(19) United States
(12) Patent Application Publication
(10) Pub. No.: US 2007/0218218 A1
(43) Pub. Date: Sep. 20, 2007

(54) Cellulose acylate optical film, producing method thereof, polarizing plate and liquid crystal display using the same

(75) Inventors: Emiko Kataoka, Tokyo (JP); Akihiko Takeda, Sagamihara-shi (JP); Kazuaki Nakamura, Kyoto-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 11/716,468

(22) Filed: Mar. 9, 2007

(30) Foreign Application Priority Data
Mar. 20, 2006 (JP) JP2006-076364

(51) Int. Cl. C09K 19/00; C08B 5/00

(52) U.S. Cl. 428/1.31; 536/32

(57) ABSTRACT

A cellulose acylate film comprising a polymer derived from at least a monomer represented by Formula 1 and a cellulose acylate having an acyl group of 3 or more carbon atoms, wherein a total number of carbon atoms contained in the acyl groups in one it of the cellulose acylate is larger than 6.0 and not larger than 7.5, wherein the total number of carbon atoms represents a sum of each product of a number of carbon atoms of each acyl group and a substitution degree of the acyl group, wherein the substitution degree represents an average number of 3 hydroxyl groups replaced with an acyl group in one glucose unit of the cellulose acylate:

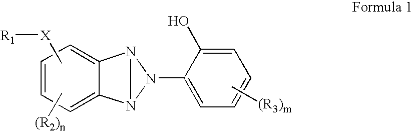

This application is based on Japanese Patent Application No. 2006-076364 filed on Mar. 20, 2006 in Japanese Patent Office, the entire content of which is hereby incorporated by reference.

### FIELD OF THE INVENTION

The present invention relates to an optical film to be applied for an optical use, specifically relates to an optical film applicable to a polarizing plate protection film, a retardation film and a viewing angle expanding film for a liquid crystal display; an antireflection film for a plasma display; and various kinds of functional film for an organic EL display, and in more detail relates to an optical film exhibiting minimal unnecessary coloration, excellent color reproducibility, small variation of retardation values due to humidity, superior durability and superior light-resistance, as well as to a polarizing plate and a liquid crystal display using the optical film.

### BACKGROUND OF THE INVENTION

The optical film used in the above technical field has problems such as that decomposition of the film is accelerated resulting in lowing the strength thereof and the transparency is decreased by coloring when the film is exposed to light containing UV rays. Therefore, the optical film which is required to have high transparency is protected from the deterioration by UV rays by previously mixing a UV absorbent such as a benzotriazole type compound, benzophenone type compound, a cyanoacrylate type compound and a salicylic acid type compound. However, many of these conventional UV absorbents exhibit lower solubilities. Consequently, they cause various problems such as that the UV absorbent easily bleeds out, easily deposits on the surface of the film and lowers the transparency due to increase of haze, moreover the UV absorbing ability is lowered by evaporation when the optical film is heated in the course of production process which also causes contamination of the production equipment.

Trials for solving such the problems are described in Japanese Patent Publication Open to Public Inspection (hereafter referred to as JP-A) Nos. 60-38411, 62-181360, 3-281685 and 7-90184, in which the UV absorbents are made into a form of UV absorbing polymer by introducing a polymerizable group into the UV absorbent. Example of optical film for polarizing plate protective film containing a UV absorbing polymer is described in JP-A No. 6-148430.

The UV absorbing polymers described in these documents surly show some degree of effect to prevent the bleeding out and evaporating out but they are insufficient in the UV absorbing ability and a large amount of them is necessary for obtaining sufficient UV absorbing effect. However, the addition of large amount of the UV absorbing polymer poses problems such as that sufficient transparence cannot be obtained or the film is colored yellowish because the compatibility of the UV absorbing polymer with the resin is insufficient, and the UV absorbing ability is lowered during storage for long time. Therefore, such the film is difficultly applied for the optical film.

It is required for the optical film to satisfactorily cutoff UV rays of not more than 380 nm and to satisfactorily permeate light of not less than 400 nm, and various UV absorbents are proposed.

For example, 2′-hydroxyphenylbenzotriazole type UV absorbents which have an amide group, a carbamoyl group, an ester group or an acyloxy group as the substituent are described in JP-A No. 2003-113317. This patent document discloses that the bleeding out and the contamination of the processing equipment by evaporation of the UV absorbent can be inhibited by using polymer derived from one of such the UV absorbent monomer having the specified substituent.

On the other hand, cellulose ester film has a defect that the retardation is largely varied depending on humidity. It is strongly required to improve such the defect because it causes light leaking from the polarizing plate during the use for long time. Hitherto, (1) a method by adding a low molecular highly hydrophobic compound and (2) a method by raising the hydrophobicity of cellulose acylate itself are proposed.

Regarding the above (1), a film with low humidity dependency of retarding value is disclosed in JP-A No. 2001-114914. Regarding the above (2), a sheet of cellulose acylate which has a substitution degree of acyl group having three or more carbon atoms of 0.3 to 0.8 is disclosed in JP-A No. 8-231761 and a sheet of cellulose acylate having a acetyl substituted degree of 1.4 to 2.85 and a total substituting degree of 2.3 to 2.85 is disclosed in JP-A No. 2003-170492.

However, the humidity dependency of retardation is still large and the improvement is not fully sufficient, though certain effects can be obtained by the above improving methods.

### SUMMARY OF THE INVENTION

An object of the present invention is to provide an optical film which has superior spectral absorbing ability for the use of optical film, high transparency without coloring, sufficient UV absorbing ability and small variation of retardation caused by humidity, and a polarizing plate and liquid crystal display using the optical film, and to provide a production method of the optical film.

One of the aspects of the present invention to achieve the above object is a cellulose acylate optical film comprising a polymer derived from at least a monomer represented by Formula 1 and a cellulose acylate having an acyl group of 3 or more carbon atoms, wherein a total number of carbon atoms contained in the acyl groups in one glucose unit of the cellulose acylate is larger than 6.0 and not larger than 7.5, wherein the total number of carbon atoms represents a sum of each product of a number of carbon atoms of each acyl group and a substitution degree of the acyl group, wherein the substitution degree represents an average number of 3 hydroxyl groups replaced with an acyl group in one glucose unit of the cellulose acylate.

### DESCRIPTION OF THE PREFERRED EMBODIMENTS

The above object of the present invention is achieved by the following structures.

(1) A cellulose acylate optical film comprising a polymer derived from at least a monomer represented by Formula 1 and a cellulose acylate having an acyl group of 3 or more carbon atoms, wherein

a total number of carbon atoms contained in the acyl groups in one glucose unit of the cellulose acylate is larger than 6.0 and not larger than 7.5, wherein the total number of carbon atoms represents a sum of each product of a number of carbon atoms of each acyl group and a substitution degree of the acyl group, wherein the substitution degree represents an average number of 3 hydroxyl groups replaced with an acyl group in one glucose unit of the cellulose acylate:

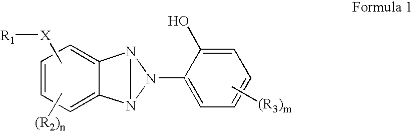

wherein R₁ represents a substituent having a polymerizable group as a substructure; R₂ and R₃ each represent a substituent; X represents —COO—, —OCO—, —NR₁₁CO—, —CONR₁₁—, —O—, —NR₁₂R₁₃—, —SO₂NR₁₄—, —NR₁₄SO₂—, —S— or —SO₂—; R₁₁, R₁₂, R₁₃, R₁₄ each represent a hydrogen atom, an alkyl group or an aryl group; m represents an integer of 0 to 4; and n represents an integer of 0 to 3.

(2) The cellulose acylate optical film of Item (1), wherein a weight average molecular weight of the polymer is 1000 to 20000.

(3) The cellulose acylate optical film of Item (1) or (2), wherein a content of a monomer unit represented by Formula 1 is 10 to 70% by weight based on a weight of the polymer derived from at least the monomer represented by Formula 1.

(4) The cellulose acylate optical film of any one of Items (1) to (3), wherein the polymer derived from at least a monomer represented by Formula 1 is a copolymer derived from at least a hydrophilic monomer having an ethylenically unsaturated group and a monomer represented by Formula 1.

(5) The cellulose acylate optical film of any one of Items (1) to (4), wherein the monomer represented by Formula 1 is a monomer represented by Formula 2:

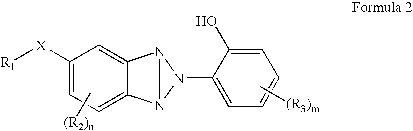

wherein R₁ represents a substituent having a polymerizable group as a substructure; R₂ and R₃ each represent a substituent; X represents —COO—, —OCO—, —NR₁₁CO—, —CONR₁₁—, —O—, —NR₁₂R₁₃—, —SO₂NR₁₄—, —NR₁₄SO₂—, —S— or —SO₂—; R₁₁, R₁₂, R₁₃, R₁₄ each represent a hydrogen atom, an alkyl group or an aryl group; m represents an integer of 0 to 4; and n represents an integer of 0 to 3.

(6) The cellulose acylate optical film of any one of Items (1) to (5), wherein X in Formula 1 or in Formula 2 represents —COO—, —OCO—, —NR₁₁CO— or —CONR₁₁—.

(7) A method to produce a cellulose acylate optical film comprising the steps of:

(i) melting a cellulose acylate;

(ii) casting the cellulose acylate melt on a cooling drum or an endless belt to form a film;

(iii) peeling the film from the cooling drum or the endless belt;

(iv) stretching the film; and

(v) winding the film to form a roll, wherein

(a) the cellulose acylate optical film comprises a polymer derived from at least a monomer represented by Formula 1 and a cellulose acylate having an acyl group of 3 or more carbon atoms; and

(b) a total number of carbon atoms contained in the acyl groups in one glucose unit of the cellulose acylate is larger than 6.0 and not larger than 7.5, wherein the total number of carbon atoms represents a sum of each product of a number of carbon atoms of each acyl group and a substitution degree of the acyl group, wherein the substitution degree represents an average number of 3 hydroxyl groups replaced with an acyl group in one glucose unit of the cellulose acylate:

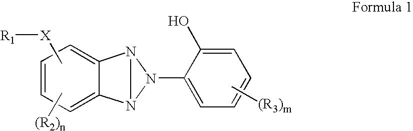

wherein R₁ represents a substituent having a polymerizable group as a substructure; R₂ and R₃ each represent a substituent; X represents —COO—, —OCO—, —NR₁₁CO—, —CONR₁₁—, —O—, —NR₁₂R₁₃—, —SO₂NR₁₄—, —NR₁₄SO₂—, —S— or —SO₂—; R₁₁, R₁₂, R₁₃, R₁₄ each represent a hydrogen atom, an alkyl group or an aryl group; m represents an integer of 0 to 4; and n represents an integer of 0 to 3.

(8) A polarizing plate comprising the cellulose acylate optical film of any one of Items (1) to (6) provided on at least one surface of a polarizer film.

(9) A liquid crystal display comprising the polarizing plate of Item (8) provided at least on one surface of a liquid crystal cell.

The inventors have investigated about the optical film containing a UV absorbent capable of solving the above problems. As a result of the investigation, it has been found that, by incorporating a UV absorbent having a specified structure in a cellulose acylate film, the cellulose acylate having an acyl group of 3 or more carbon atoms and a total number of carbon atoms contained in the acyl groups in one glucose unit of the cellulose acylate of larger than 6.0 and not larger than 7.5, an optical film which has superior spectral absorbing ability, high transparency without coloring, sufficient UV absorbing ability, small variation in the retardation variation depending on humidity and excellent weather resistance for long duration can be obtained.

In more detail, it has been found that excellent properties such as effect of prevention of bleed out and reduction of contamination of production process by evaporation, small retardation variation depending on humidity and excellent weather resistance for long duration and enhancement of the contrast of liquid crystal display can be obtained when a UV absorbent of copolymer formed by polymerizing a linking group of the benzotriazole ring of a 2-hydroxyphenylbenzotriazole UV absorbent is used in a cellulose acylate film, the cellulose acylate having an acyl group of 3 or more carbon atoms and a total number of carbon atoms contained in the acyl groups in one glucose unit of the cellulose acylate of larger than 6.0 and not larger than 7.5.

By the above constitution of the present invention, an optical film excellent in the UV absorbing property, transparency, durability (anti-bleeding out property), light-resistance and small dependency of retardation on humidity, and a polarizing plate and liquid crystal display having high image contrast employing the optical film can be provided.

The cellulose acylate optical film of the present invention is characterized in that the cellulose acylate optical film mainly contains a cellulose acylate having at least an acyl group of 3 or more carbon atoms, and containing at least a polymer derived from a monomer represented by Formula 1, the total number of carbon atoms contained in the acyl groups in one glucose unit of the cellulose acylate being larger than 6.0 and not larger than 7.5 provided that the total carbon number of acyl group is the sum of each product of substitution degree of each acyl group and the number of carbon atoms in the acyl group.

Cellulose is a natural substance composed of many D-glucose molecules bonding in a straight chain form. In D-glucose molecule, hydroxyl groups are each bonded to the carbon atoms of 1- to 4- and 6-positions. The chain of cellulose is constituted by ether bonds each formed by condensation of the aldehydic hydroxyl group at the carbon atom of 1-position and the alcoholic hydroxyl group at the carbon atom of 4-position. The carbon atom at 6-position is a carbon atom of the methyl group branched from the carbon atom at 5-position and the hydroxyl group at 6-position is a substituent of the hydrogen atom of the methyl group and has a structure projected from the hexagonal chain of the glucose molecule.

Cellulose acylate is a polymer in which all or a part of hydroxyl groups bonded to the carbon atoms at 2-, 3- and 6-positions of the glucose unit are esterified by an acyl group. The “substitution degree by acyl group” is a measure representing the number of the hydroxyl groups bonded with the acyl groups among 3n hydroxyl groups (n is polymerization degree). The substitution degree is represented by the average number of hydroxyl groups substituted with an acyl group among the three hydroxyl groups at 2-, 3 and 6-positions per glucose unit. Accordingly, the substitution degree comes up to the maximum of 3.0 when the three hydroxyl groups are entirely esterified by the acyl groups.

The present invention and the constitution thereof are described in detail below.

(Monomer Represented by Formula 1)

In Formula 1, R₁ is a substituent having a polymerizable group as a substructure thereof, and the polymerizable group is an ethylenically unsaturated polymerizable group or a di-functional type condensate-polymerizable group and preferably the ethylenically unsaturated polymerizable group. Concrete examples of the ethylenically unsaturated polymerizable group include a vinyl group, an aryl group, an acryloyl group, a methacryloyl group, a styryl group, an acrylamido group, a methacrylamido group, a vinyl cyanide group, a 2-cyanoacryloxy group, a 1,2-epoxy group, a vinylbenzyl group and a vinyl ether group, and the vinyl group, acryloyl group, methacryloyl group, acrylamido group and methacrylamido group are preferable. The definition of “having the polymerizable group as partial structure” means that the polymerizable group is bonded directly or through a di- or more-valent linking group. Examples of the di- or more-valent linking group include an alkylene group such as a methylene group, a 1,2-ethylene group, a 1,3-propylene group, a 1,4-butylene group and a cyclohexane-1,4-di-yl group, an alkenylene group such as an ethane-1,2-di-yl group and a butadiene-1,4-di-yl group, a linking group derived from a compound including at least one aromatic group such as a substituted or unsubstituted benzene, a condensed polycyclic hydrocarbon, an aromatic heterocyclic ring, an aromatic hydrocarbon ring aggregate and an aromatic heterocyclic ring aggregate, a linking hetero-atom such as an oxygen atom, a sulfur atom, a nitrogen atom, a silicon atom and a phosphor atom, and the alkylene group and the hetero-atom linkage are preferred. These linking groups may be combined with together to form a composite group. R₂ and R₃ are each a substituent and examples of it include a halogen atom such as a fluorine atom, a chlorine atom, a bromine atom and an iodine atom, and alkyl group such as a methyl group, an ethyl group, an isopropyl group, a hydroxyethyl group, a methoxymethyl group, a trifluoromethyl group and a t-butyl group, an alkenyl group such as a vinyl group, a allyl group and a 3-butene-1-yl group, an aryl group such as a phenyl group, a naphthyl group, a p-tolyl group and a p-chlorophenyl group, an alkoxy group such as a methoxy group, an ethoxy group, an isopropoxy group and an n-butoxy group, an aryloxy group such as a phenoxy group, an acyloxy group such as an acetoxy group, a pivaloyloxy group and a benzoyloxy group, an acyl group such as an acetyl group, a propanoyl group and a butyloyl group, an alkoxycarbonyl group such as a methoxycarbonyl group and an ethoxycarbonyl group, an aryloxycarbonyl group such as a phenoxycarbonyl group, a carbamoyl group such as a methylcarbamoyl group, an ethylcarbamoyl group and a dimethylcarbamoyl group, an amino group, an alkylamino group such as a methylamino group, an ethylamino group and a diethylamino group, an anilino group such as an anilino group and an N-methylanilino group, an acylamino group such as an acetylamino group and a propionylamino group, a hydroxyl group, a cyano group, a nitro group, a sulfonamido group such as a methanesulfonamido group and a benzenesulfonamido group, a sulfamoylamino group such as a dimethylsulfamoylamino group, a sulfonyl group such as a methanesulfonyl group, a butanesulfonyl group and a phenylsulfonyl group, a sulfamoyl group such as an ethylsulfamoyl group and a dimethylsulfamoyl group, a sulfonylamino group such as a methanesulfonylamino group and a benzenesulfonylamino group, an ureido group such as 3-methylureido group, a 3,3-dimethylureido group and 1,3-dimethylureido group, an imido group such as a phthalimido group, a silyl group such as a trimethylsilyl group, a triethylsilyl group and a t-butyldimethylsilyl group, an alkylthio group such as a methylthio group, an ethylthio group and an n-butylthio group and an arylthio group such as a phenylthio group. Among them, the aryl group and the aryl group are preferable.

R₁₁, R₁₂, R₁₃ and R₁₄ are each a hydrogen atom, an alkyl group such as a methyl group, an ethyl group, an isopropyl group, a hydroxyethyl group, a methoxymethyl group, a trifluoromethyl group and a t-butyl group, or an aryl group such as a phenyl group, a naphthyl group, a p-tolyl group and a p-chlorophenyl group.

Examples of the monomer represented by Formula 1 are listed below but the compound of the present invention is not limited thereto.

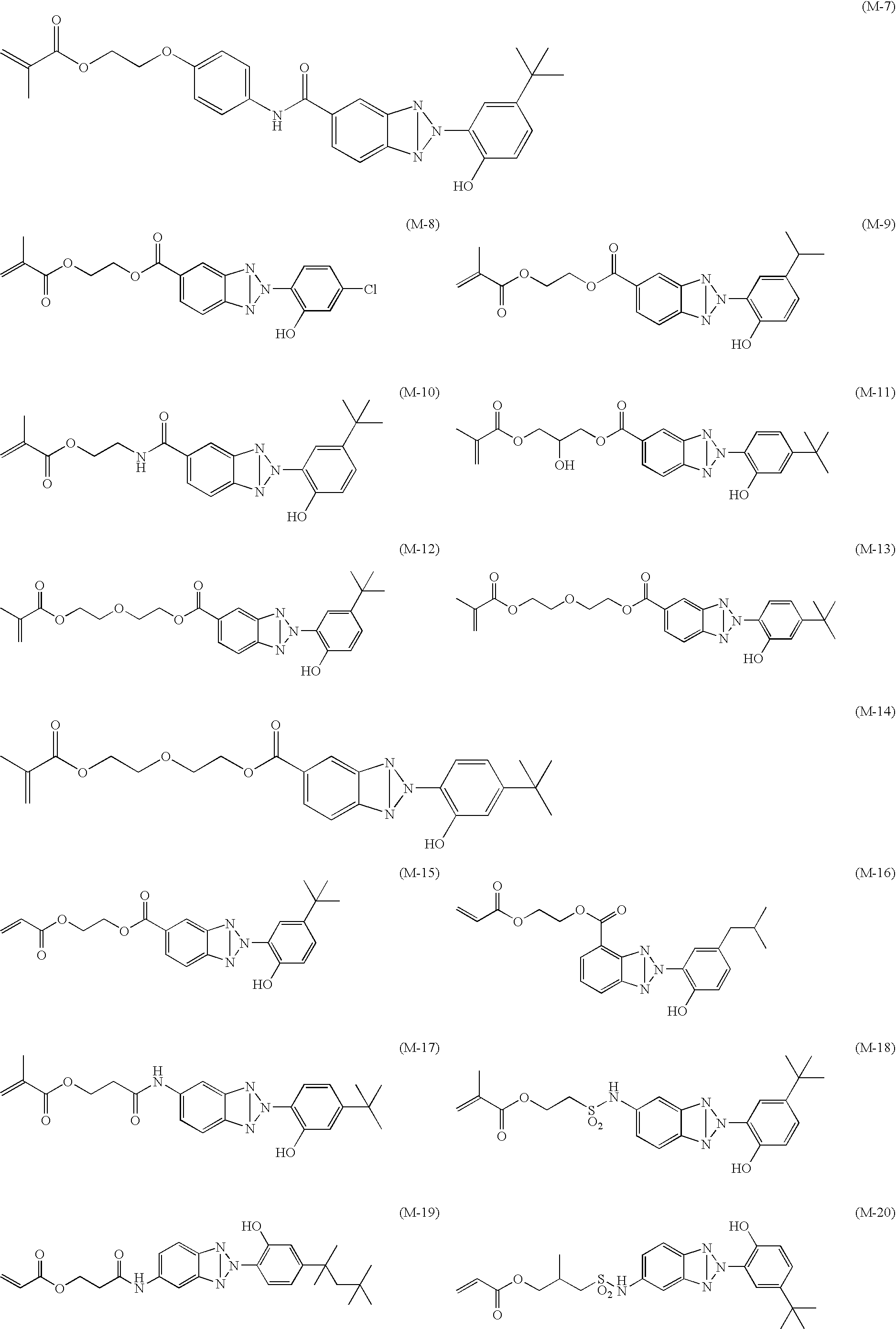

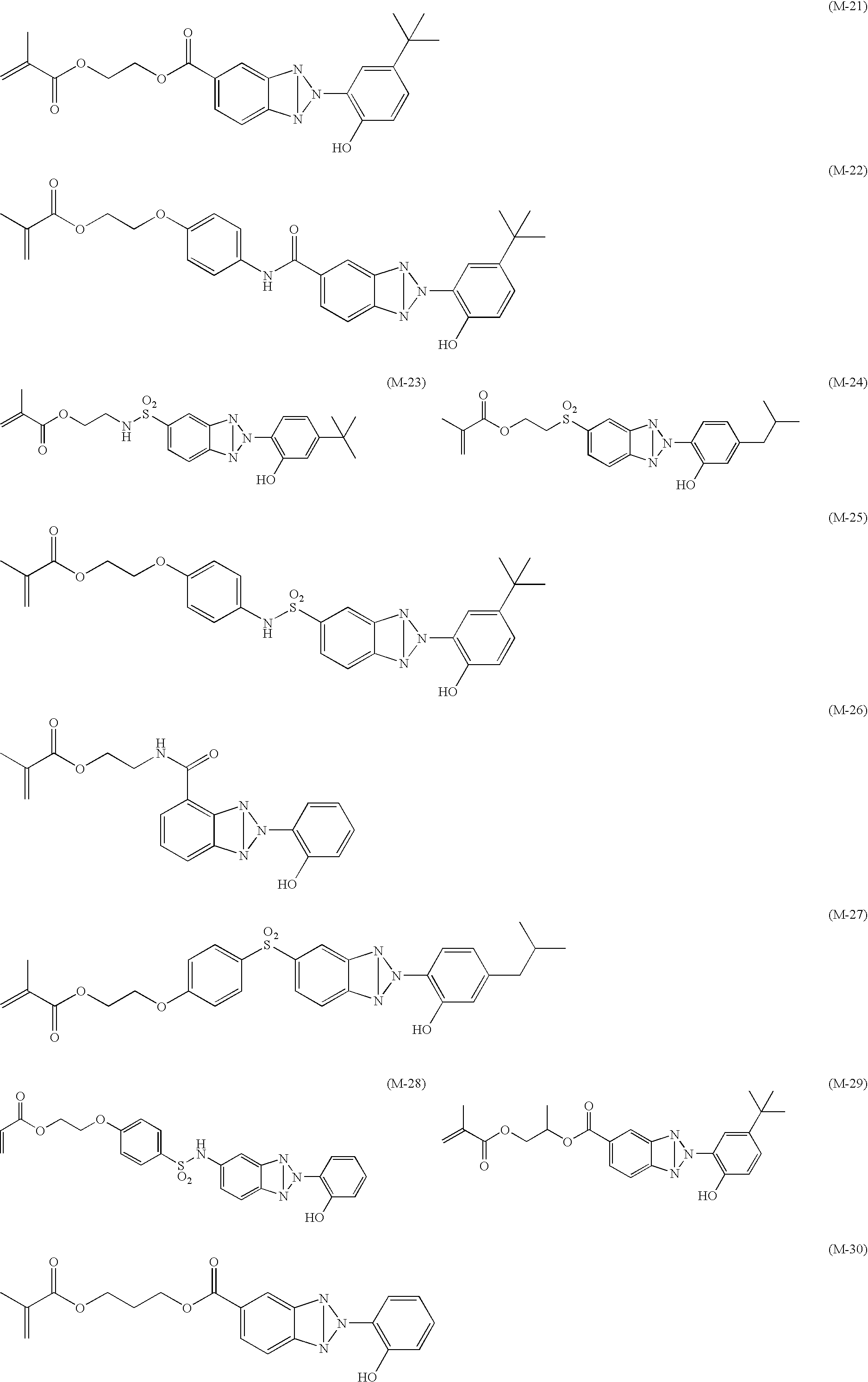

The polymer derived from the monomer represented by Formula 1 relating to the present invention may be used together with a low molecular or high molecular compound or an inorganic compound on the occasion of mixing with another transparent polymer. For example, it is a preferable embodiment to mix with an additive such as an antioxidant, a plasticizer and a flame retardant. The weight average molecular weight of

The UV absorbent of the present invention may be added into the optical film or coated on the optical film. The UV absorbent may be directly added when the UV absorbent is added into the optical film.

Using amount of the UV absorbent according to the present invention is preferably from 0.2 to 8.0 g, more preferably from 0.4 to 5.0 g, and particularly preferably from 1.0 to 3.0 g, per square meter of the optical film though the amount is varied depending on the kind of the compound and the using condition. The UV absorbent superior in the absorbing ability for UV rays of not more than 380 nm and low in the visible light absorption of not less than 400 nm is preferable from the viewpoint of deterioration of liquid crystal and the suitable displaying ability of the liquid crystal, respectively. In the present invention, transmittance at 380 nm is preferably not more than 8%, more preferably not more than 4%, and particularly preferably not more than 1%.

In the present invention, the UV absorbent of the present invention may be used together with another known UV absorbent. As examples of the known UV absorbent, a salicylic acid type UV absorbent such as phenyl salicylate and p-tert-butyl salicylate, a benzophenone type UV absorbent such as 2,4-dihydroxy-benzophenone and 2,2′-dihydroxy-4,4′-dimethoxybenzophenone, a benzotriazole type UV absorbent such as 2-(2′-hydroxy-3′-tert-butyl-5′-methylphenyl)-5-chlorobenzotriazole, 2-(2′-hydroxy-3′,5′-di-tert-butyl-phenyl)-5-chloro-benzotriazole and 2-(2′-hydroxy-3′,5′-di-tert-amyl-phenyl)-benzotriazole, a cyanocarylate type UV absorbent such as 2′-ethylhexyl-2-cyano-3,3-diphenyl acrylate and ethyl-2-cyano-3-(3′,4′-methylenedioxyphenyl)acrylate, a triazine type UV absorbent, the compounds described in JP-A No. 58-185677 and 59-149350, a nickel complex type compound and an inorganic powder can be cited.

As the known UV absorbents to be used together with the polymer derived from the monomer represented by Formula 1 according to the present invention, the benzotriazole type and the benzophenone type UV absorbents are preferable since they have high transparency and are superior in the effect for preventing deterioration of the polarizing plate and the liquid crystal element, and the benzotriazole type UV absorbent, which is less in unnecessary coloration, is particularly preferred.

(Polymer Derived from the Monomer Represented by Formula 1)

The optical film of the present invention is characterized in that the film is mainly comprised of cellulose acylate containing at least one of the polymers derived from the compound represented by Formula 1.

Weight average molecular weight of the polymer according to the present invention can be controlled by known molecular weight controlling methods. Such the controlling methods include a method by adding a chain transferring agent such as carbon tetrachloride, laurylmercaptane and octyl thioglycolate, and a method by adding a polymerization initiator different in the decomposing rate. Polymerization temperature is usually within the range of from room temperature to 130° C. and preferably from 30° C. to 100° C.

The polymer according to the present invention may be a homopolymer derived from the monomer represented by Formula 1 only or a copolymer together with another polymerizable monomer. Examples of the monomer capable of copolymerizing with the monomer represented by Formula 1 include a styrene derivative such as styrene, α-methylstyrene, o-methylstyrene, m-methylstyrene, p-methylstyrene and vinylnaphthalene, an acrylate derivative such as methyl acrylate, ethyl acrylate, propyl acrylate, butyl acrylate, i-butyl acrylate, t-butyl acrylate, octyl acrylate, cyclohexyl acrylate and benzyl acrylate, a methacrylate derivative such as methyl methacrylate, ethyl methacrylate, propyl methacrylate, butyl methacrylate, i-butyl methacrylate, 2-hydroxyethyl methacrylate, octyl methacrylate, cyclohexyl methacrylate and benzyl methacrylate, an alkyl vinyl ether such as methyl vinyl ether, ethyl vinyl ether and butyl vinyl ether, an alkyl vinyl ester such as vinyl formate, vinyl acetate, vinyl butylate, vinyl capronate and vinyl stearate, and an unsaturated compound such as crotonic acid, maleic acid, fumalic acid, itaconic acid, acrylonitrile, methacrylonitile, vinyl chloride, vinylidene chloride, acrylamide and methacrylamide. Methyl acrylate, 2-hydroxyethyl acrylate, methyl methacrylate, 2-hydroxyethyl methacrylate and vinyl acetate are preferable.

(Production Method of Cellulose Ester Film)

The production method of the cellulose ester film in the preferable embodiment of the present invention is described below.

The film forming process for producing the cellulose ester film of the present invention is preferably a melt-casting method in which cellulose ester is melted by heating without use of any solvent at a temperature at which the cellulose ester shows fluidity, and then the melted cellulose ester is cast to form a film. The melt casting method can be classified in detail into, for example, a melt-extrusion method, a press forming method, an inflation method, an ejection forming method, a blow forming method and an elongation forming method. Preferably, the film constituting material is fluidized by heating and then extruded onto a drum or an endless belt to form a film.

(Cellulose Acylate)

A lower fatty acid ester of cellulose is preferably used for the cellulose acylate to be used in the present invention.

The lower fatty acid in the lower fatty acid cellulose ester is a fatty acid having 6 or less carbon atoms. Examples of the lower fatty acid cellulose acylate include cellulose acetate, cellulose propionate, cellulose butylate, and a mixed fatty acid cellulose ester such as cellulose acetate propionate and cellulose acetate butylate described in JP-A Nos. 10-45804 and 8-231761, and U.S. Pat. No. 2,319,052. Among the above esters, cellulose acetate propionate is preferably used. In the case of the cellulose acylate film of the present invention, one having a polymerization degree of from 250 to 400 is preferably used from the viewpoint of the physical strength of the film.

In the present invention, cellulose acylate constituting the optical film contains, as a main component, a cellulose acylate having an aliphatic acyl group of 3 or more carbon atoms and having a total carbon number of the acyl groups in one glucose unit of larger than 6.0 and not larger than 7.5. The total carbon number of acyl group of the cellulose acylate is preferably 6.2 to 7.5 and more preferably 6.5 to 7.2 and specifically preferably 6.6 to 7.1. The total carbon number of acyl groups (the total number of carbon atoms contained in the acyl groups in one glucose unit of the cellulose acylate) is the sum of each product of the substitution degree of each acyl group and the number of carbon atoms of the acyl group. The carbon number of the aliphatic acyl group is not specifically limited as far as the cellulose acylate contains at least an aliphatic acyl group of 3 or more carbon atoms and the total number of the carbon atoms in the acyl groups is larger than 6.0 and not larger than 7.5, however, the carbon number is preferably from 2 to 6 from the viewpoint of the production efficiency and the cost of the synthesis of the cellulose acylate. The position of the cellulose ester not substituted by the acyl group is usually occupied by a hydroxyl group. Such the cellulose esters may be synthesis by known methods.

As the acyl group, for example, an acetyl group, a propionyl group, a butylyl group, a pentanate group and a hexanate group are cited. Examples of the cellulose acylate include cellulose propionate, cellulose butylate and cellulose pentanate. A mixed fatty acid ester such as cellulose acetate propionate, cellulose acetate propionate and cellulose acetate pentanate is also employable as far as it satisfies the above total carbon number of acyl groups. Among them, cellulose acetate propionate and cellulose acetate butylate are particularly preferable. Triacetyl cellulose and diacetyl cellulose usually used for solution casting film formation are not included in the present invention because they do not satisfy the condition of the total carbon number of acyl groups.

The mechanical properties and saponification ability of the cellulose acetate film, and the melt-casting film formation property of that have a relationship of tradeoff regarding the total substitution degree of acyl groups of the cellulose acylate. For example, in the case of cellulose acetate propionate, the mechanical property is lowered and the melt-casting film formation ability is improved when the total substitution degree of acyl group is increased. Therefore, these properties are difficult to be compatible. In the present invention, it has been found that the mechanical properties, saponification ability and the melt-casting film formation property can be compatible when the total carbon number of the acyl groups in the cellulose acylate is larger than 6.0 and not larger than 7.5. It is supposed that such the result is caused by the difference between (i) the influences of the carbon number of the acyl groups on the mechanical properties of the film and the saponification ability, and (ii) the melt-casting film forming ability, though the detailed mechanism is not cleared. When the substitution degree is the same, a long chain acyl group such as propionyl group and butylyl group increase the hydrophobicity of the cellulose acylate and improve the melt-casting film formation ability compared with acetyl group having shorter chain. Accordingly, it is supposed that the degradation of the mechanical property and the saponification ability can be avoided because the substitution degree of the propionyl group or butylyl group can be kept lower than that of acetyl group in order to obtain the same melt-casting film formation ability.

The substitution degree of the acyl group in the cellulose acylate can be measured by ¹³C-NMR according to the method described in Tezuka et al. Carbohydr. Res. 273 (1955) 83-91.

The cellulose acylate to be used in the present invention has a ratio of weight average molecular weight. Mw/number average molecular weight. Mn of preferably 1.0 to 5.5, more preferably 1.4 to 5.0, and further more preferably 2.0 to 3.0, and Mw is preferably 100,000 to 500,000 particularly preferably 150,000 to 300,000.

Average molecular weight and distribution thereof of the cellulose acylate can be determined by a known method using high performance liquid chromatography. The number average molecular weight and the weight average molecular weight are determined by such the method. The measuring conditions are as follows.

Solvent: Methylene chloride

Column: Shodex K806, K805 and K803, each manufactured by Showa Denko Co., Ltd., are connected for use.

Column temperature: 25° C.

Sample concentration: 0.1% by weight

Detector: RI Model 504 manufactured by GL Science Co., Ltd.

Pump: L6000 manufactured by Hitachi Seisakusho Co., Ltd.

Flowing amount: 1.0 ml/min.

Calibration Curve: A calibration curve prepared by using 13 kinds of standard polystyrene samples having Mw of from 1,000,000 to 500, STK Standard Polystyrene manufactured by Toso Co., Ltd., was used. The differences of the Mw between each of the 13 standard samples are each preferably approximately equal.

Cellulose for the raw material of the cellulose acylate to be used in the present invention may be wood pulp or cotton linter. The wood pulp may be coniferous pulp or broad-leaved tree pulp, and the coniferous pulp is preferable. The cotton linter pulp is preferably used from the viewpoint of peeling ability on the occasion of film formation. Cellulose acylates produced from these raw materials may be used singly or in suitable combination.

For example, mixing ratios of cellulose acetate derived from the cotton linter:cellulose acylate derived from the coniferous pulp:cellulose acylate derived from the broad-leaved tree pulp of 100:0:0, 90:10:0, 85:15:0, 50:50:0, 20:80:0, 10:90:0, 0:100:0, 0:0:100, 80:10:10, 85:0:15 and 40:30:30 are available.

The cellulose acylate can be obtained, for example, by substituting hydroxyl groups of the raw material cellulose by acetyl group, propionyl group and/or butyl group by usual method using acetic anhydride, propionic anhydride and/or butylic anhydride so that the substitution degree becomes within the above described range. The cellulose acetate can be synthesized referring the methods described In JP-A No. 10-45804 and Published Japanese Translation of PCT International Publication No. 6-501040 though the method is not specifically limited.

The substitution degree of acetyl group, propionyl group or butyl group can be measured according to ASTM-D817-96.

Cellulose acylate is industrially synthesized using sulfuric acid as a catalyst and the sulfuric acid is incompletely removed. The remaining sulfuric acid causes various decomposition reactions on the occasion of the melting film formation and influences to the quality of the obtained cellulose acylate film. Therefore, remaining amount of the sulfuric acid in the cellulose acylate film to be used in the present invention is from 0.1 to 40 ppm in terms of sulfur. It is supposed that the sulfuric acid is contained in a form of salt. A sulfuric acid content exceeding 40 ppm is not preferable since substance adhering at the lip portion of the die is increased on the occasion of melting by heat, furthermore, the film is tends to easily broken on the occasion of heat stretching and slitting after the stretching. A smaller amount of the remaining sulfuric acid is preferable but load on the washing process of cellulose acylate is excessively increased for reducing the remaining sulfuric acid to less than 0.1 ppm. Furthermore, the film tends to be easily broken. Accordingly, such the condition is not preferable. It is supposed that the increasing in the washing times influences the resin though the reason is not cleared. The remaining sulfuric acid amount is more preferably from 0.1 to 30 ppm. The remaining amount of sulfuric acid can be measured according to ASTM-D871-96.

The total amount of remaining acid including another acid such as acetic acid is preferably not more than 1,000 ppm, more preferably not more than 500 ppm and further preferably not more than 100 ppm. The amount of remaining acid can be made within the above range by applying more sufficient washing to the cellulose acylate compared with that to be used in a solution casting method so that the adhering substance at the lip portion on the occasion of film formation by melt-casting method is reduced and a film excellent in flatness can be obtained. Thus obtained film is superior in the dimension stability, mechanical strength, transparency, resistance to moisture permeation, and the later-mentioned Rt and Ro values. For washing the cellulose acylate, a poor solvent such as methanol and ethanol or a mixted poor solvent composed of a poor solvent and a good solvent can be used additionally to water. By such the method, an inorganic substance and a low molecular weight organic impurity can be removed. Moreover, the washing of the cellulose acylate is preferably carried out in the presence of an antioxidant such as a hindered amine and a phosphite. Heat-resistance and stability of film formation are improved by such the treatment.

The low molecular weight component and another impurity can be removed for raising the heat resistance, mechanical property and optical property of the cellulose acylate by dissolving the cellulose acetate by a good solvent and re-precipitated in a poor solvent. Such the process is preferably performed in the presence of the antioxidant the same as in the above washing process. After the re-precipitation treatment, another polymer or a low molecular weight compound may be added to the cellulose acylate.

Limiting viscosity of the cellulose acylate is preferably from 1.5 to 1.75 g/cm³ and more preferably from 1.53 to 1.63 g/cm³.

The cellulose acylate to be used in the present invention is preferably one containing few brightening foreign substance after formed in the film. The brightening foreign substance is a point through which light from the light source is leaked and observed as a brightening point when the cellulose acylate film is placed between two polarizing plates each arranged for forming a right angle (cross nicols state). The polarizing plates to be used for such the evaluation are preferably protected by a protective film containing no brightening foreign substance and ones protected by a glass plate are preferably used. It is supposed that one of the causes of the brightening foreign substance is non acetylated or low acetylated cellulose. The film containing few brightening foreign substance can be obtained by using cellulose acylate containing few brightening substance (cellulose acylate small in the scattering of the substitution degree), by filtering the melted cellulose acylate or by filtering the cellulose acylate once dissolved into a solution state for removing the brightening freight substance. The later method is higher in the producing efficiency since the melted resin has high viscosity.

The number of the brightening foreign substance per unit area tends to be less when the thickness of film is smaller and the content of the cellulose acylate in the film is lower. Number of the brightening foreign substance having a diameter of not less than 0.01 mm is preferably not more than 200/cm², more preferably not more than 100/cm³, more preferably not more than 50/cm³ and further particularly preferably not more than 30/cm³, particularly preferably not more than 10/cm³, and most preferably not contained at all. Moreover, number of the brightening foreign substance having a diameter of from 0.005 to 0.01 mm is preferably not more than 200/cm², more preferably not more than 100/cm³, more preferably not more than 50/cm³ and further particularly preferably not more than 30/cm³, particularly preferably not more than 10/cm³, and most preferably not contained at all.

When the brightening foreign substance is removed by the melt-filtering, it is more preferable to filter a cellulose acylate composition containing an additive such as a plasticizer, a deterioration preventing agent and an antioxidant rather than to filter a singly melted cellulose acylate because the former method is higher in the brightening foreign substance removing efficiency. Of course, it is allowed that the cellulose acylate is dissolved in a solvent on the occasion of synthesis thereof and filtered for reducing the brightening foreign substance. The solution containing the UV absorbent and another additive may be filtered. Viscosity of the melted material containing the cellulose acylate on the occasion of filtering is preferably not more than 10,000 P, more preferably not more than 5,000 P, more preferably not more than 1,000 P and further preferably not more than 500 P. As the filter, known material such as glass fiber, cellulose fiber, filter paper, and a fluororesin such as ethylene tetrachloride resin are preferably and ceramics and metal are particularly preferably used. Absolute filtering precision of the filter is preferably not more than 50 μm, more preferably not more than 30 μm, more preferably not more than 10 μm and further preferably not more than 5 μm. These filters can be used in suitable combination. A surface type and depth type filter are also usable. The depth type filter is preferably used, which difficultly causes blocking.

In another embodiment of the present invention, the cellulose acylate may be one prepared by once dissolving in a solvent and drying to remove the solvent. In such the case, the cellulose acylate is used, which is prepared by dissolved in the solvent together with at least one of the plasticizer, UV absorbent, degradation preventing agent, antioxidant and matting agent and then drying. As the solvent, a good solvent usually used in the solution casting method such as methylene chloride, methyl acetate and dioxoran are usable and a poor solvent such as methanol, ethanol and butanol also may be used in the same time. In the course of the dissolution, the solution may be cooled by −20° C. or less and heated by 80° C. or more. The additives in the melted resin can be easily made uniform and the optical property sometimes can be made uniform by the use of such the cellulose acylate.

The optical film of the present invention may be one in which a high molecular weight component other than the cellulose acylate is suitably mixed. The high molecular weight component to be mixed is preferably one superior in the compatibility with the cellulose acylate. It is preferable that the film prepared by such the material preferably has a transmittance of not less than 80%, more preferably not less than 90% and further preferably not less than 92%.

### (Plasticizer)

In the optical film of the present invention, a plasticizer may be added. In general, to add a compound known as a plasticizer is preferable to improve the properties of the film, for example, improving a physical property, providing flexibility, reducing water-absorbability and reducing moisture permeability. In the melt casting method employed in the present invention, the purposes to add a plasticizer include, for example: lowering the melting temperature of the film forming materials to a temperature lower than the glass transition temperature of a cellulose acylate containing no additive; and lowering the viscosity of the melt of the film forming materials compared to the viscosity of a cellulose acylate containing no additive heated at the same temperature. The melting temperature of the film forming materials represents, in the present invention, a temperature at which the film forming materials exhibit fluidity by heating.

At a temperature lower than the glass transition temperature of a cellulose acylate containing no additive, the cellulose acylate does not exhibit fluidity necessary to form a film, however, when heated at a temperature higher than the glass transition temperature, the elasticity and the viscosity of the cellulose acylate are reduced by absorbing heat and fluidity is exhibited. It is preferable in order to attain the above purposes that the plasticizer added to the cellulose acylate lowers the melting temperature or the glass transition temperature of the cellulose acylate to a temperature lower than the glass transition temperature of a cellulose acylate containing no additive. An ester plasticizer prepared from a polyalcohol and a monocarboxylic acid or from a polycarboxylic acid and a monoalcohol is preferable because of its high compatibility with cellulose acylate.

In the present invention, both of or either one of an ester plasticizer prepared from a polyalcohol and monocarboxylic acid, or an ester plasticizer prepared from a polycarboxylic acid and a monoalcohol is used.

Ethylene glycol ester plasticizer which is one of polyalcohol ester plasticizers: Specific examples of an ethylene glycol ester plasticizer include: ethylene glycol alkyl ester plasticizers such as ethylene glycol diacetate and ethylene glycol dibutyrate; ethylene glycol cycloalkyl ester plasticizers such as ethylene glycol dicyclopropyl carboxylate and ethylene glycol dicyclohexyl carboxylate; and ethylene glycol aryl ester plasticizers such as ethylene glycol dibenzoate and ethylene glycol di-4-methyl benzoate. These alkylate groups, cycloalkylate groups and arylate groups may be the same or different and may further be substituted. The substituent groups may be a mixture of alkylate groups, cycloalkylate groups and arylate groups, and the substituent groups may be bonded to each other via covalent linkage. Further, the ethylene glycol portions may be substituted and the ethylene glycol ester part of the structure may be part of the polymer or may be systematically included as a pendant. It may also be introduced into a part of the molecular structure of the additives such as an antioxidant, an acid scavenger, and an ultraviolet light absorber.

Glycerin ester plasticizer which is one of polyalcohol ester plasticizers: Examples of a glycerin ester plasticizer include: glycerin alky esters such as triacetin, tributylin, glycerin diacetate caprylate and glycerin oleate propionate; glycerin cycloalkyl esters such as glycerin tricyclopropyl carboxylate, and glycerin tricyclohexyl carboxylate; glycerin aryl esters such as glycerin tribenzoate and glycerin 4-methylbenzoate; diglycerin alkyl esters such as diglycerin tetraacetylate, diglycerin tetrapropionate, digylcerin acetate tri caprylate and diglycerin tetralaurate; diglycerin cycloalkyl esters such as diglycerin tetracylobutyl carboxylate and diglycerin tetracylopentyl carboxylate; and diglycerin aryl esters such as diglycerin tetrabenzoate and diglycerin 3-methyl benzoate. These alkylate groups, cycloalkyl carboxylate groups and arylate groups may be same or different and may further be substituted. The substituent groups may be a mixture of an alkylate group, a cycloalky carboxylate group and an arylate groups, and the substituent groups may be bonded to each other via covalent bond. Further, the glycerin and diglycerin portions may be substituted and a partial structure of the glycerin ester or diglycerin ester may be a part of the polymer or may be systematically included as a pendant. It may also be introduced into a part of the molecular structure of the additive such as an antioxidant, an acid scavenger, and an ultraviolet light absorber.

Other polyalcohol ester plasticizers: Specific examples of polyalcohol ester plasticizers include the polyalcohol ester plasticizers disclosed in JP-A 2003-12823, paragraphs 30-33.

These alkylate groups, cycloalkyl carboxylate groups and arylate groups may be the same or different and may be further be substituted. The alkylate groups, cycloalky carboxylate groups and arylate groups may be mixed, and the substituent groups may be bonded to each other via covalent bond. Furthermore, the polyhydric alcohol portion may be substituted and a partial structure of the polyhydric alcohol may be a part of the polymer or may be systematically included as a pendant. It may also be introduced into a part of the molecular structure of the additives such as an antioxidant, an acid scavenger or an ultraviolet light absorber.

Among the above described ester plasticizers derived from a polyalcohl and a monocarboxylic acid, for example, an aryl ester of an alkyl-polyalcohol is preferable, specific examples of which include: an ethyleneglycoldibenzoate, a glycerintribenzoate, a diglycerintetrabenzoate and exemplified compounds 16 disclosed in JP-A No. 2003-12823 paragraph 32.

Dicarboxylic acid ester plasticizer which is one of the polycarboxylic acid esters: Specific examples of a dicarboxylic acid ester plasticizer include: alkyl dicarboxylic acid cycloalkyl ester plasticizers such as didodecyl malonate, dioctyl adipate and dibutyl cebacate; alkyl dicarboxylic acid cycloalkyl ester plasticizers such as dicyclopentyl succinate and dicyclohexyl adipate; alkyl dicarboxylic acid aryl ester plasticizers such as diphenyl succinate and di-4-methyl phenyl glutarate; cycloalkyl dicarboxylic acid alkyl ester plasticizers such as dihexyl-1,4-cyclohexane dicarboxylate and didecyl bicyclo [2.2.1]heptane-2,3-dicarboxylate; cycloalkyl dicarboxylic acid cycloalkyl ester plasticizers such as dicyclohexyl-1,2-cyclobutane dicarboxylate and dicyclopropyl-1,2-cyclohexyl dicarboxylate; cycloalkyl dicarboxylic acid aryl ester plasticizers such as diphenyl-1,1-cyclopropyl dicarboxylate and di-2-naphthyl-1,4-cyclohexane dicarboxylate; aryl dicarboxylic acid alkyl ester plasticizers such as diethyl phthalate, dimethyl phthalate, dioctyl phthalate, dibutyl phthalate and di-2-ethylhexyl phthalate; aryl dicarboxylic acid cycloalkyl ester plasticizers such as dicyclopropyl phthalate and dicyclohexyl phthalate; and aryl dicarboxylic acid aryl ester plasticizers such as diphenyl phthalate and di-4-methylphenyl phthalate. These alkoxy groups and cycloalkoxy groups may be the same or different, and may also be monosubstituted and the substitution groups may be further substituted. The alkyl groups and the cycloalkyl groups may be mixed, and the substituent groups may be bonded to each other via covalent bond. Furthermore, the aromatic ring of the phthalic acid may be substituted and may be a multimer such as a dimer, a trimer or a tetramer. The phthalic acid ester part of the structure may be a part of the polymer or may be systematically included as a pendant. It may also be introduced into a part of the molecular structure of the additives such as an antioxidant, an acid scavenger and an ultraviolet light absorber.

The adding amount of the ester plasticizer derived from a polyalcohol and a monocarboxylic acid or the ester plasticizer derived from a polycarboxylic acid and a monoalcohol is, in 100 weight parts of cellulose acylate, usually 0.1-50 weight parts, preferably 1-30 weight parts and still more preferably 3-15 weight parts.

Other polycarboxylic acid ester plasticizers: Specific examples of polyhydric carboxylic acid ester plasticizers include: alkyl polycarboxylic acid alkyl ester plasticizers such as tridodecyl tricarbalate and tributyl-meso-butane-1,2,3,4,-tetracarboxylate; alkyl polyhydric carboxylic acid cycloalkyl ester plasticizers such as tricyclohexyl tricarbalate and tricyclopopyl-2-hydroxy-1,2,3-propane tricarboxylate; alkyl polyhydric carboxylic acid aryl ester plasticizers such as triphenyl-2-hydroxyl-1,2,3-propane tricarboxylate, tetra-3-methylphenyl tetrahydrofuran-2,3,4,5-tetracarboxylate; cycloalkyl polyhydric carboxylic acid alkyl ester plasticizers such as tetrahexyl-1,2,3,4-cyclobutane tetracarboxylate and tetrabutyl-1,2,3,4,-dicyclopentane tetracarboxylate; cycloalkyl polyhydric carboxylic acid cycloalkyl ester plasticizers such as tetracyclopropyl-1,2,3,4-cyclobutane tetracarboxylate and tricyclohexyl-1,3,5-cyclohexyl tricarboxylate; cycloalkyl polyhydric carboxylic acid aryl ester plasticizers such as triphenyl-1,3,5-cyclohexyl tricarboxylate, hexa-4-methylphenyl-1,2,3,4,5,6-cyclohexyl hexacarboxylate; aryl polyhdric carboxylic acid alkyl ester based plasticizers such as tridodecyl benzene-1,2,4-tricarboxylate and tetraoctylbenzene-1,2,4,5-tetracarboxylate; aryl polyhdric carboxylic acid cycloalkyl ester plasticizers such as tricyclopentyl benzene-1,3,5-tricarboxylate and tetracyclohexyl benzene-1,2,3,5 tetracarboxylate; and aryl polyhdric carboxylic acid aryl ester plasticizers such as triphenyl benzene-1,3,5-tetracarboxylate and hexa-4-methylphenyl benzene-1,2,3,4,5,6-hexacarboxylate. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be a polymer such as a dimer, trimer, tetramer and the like. The phthalic acid ester part of the structure may be a part of the polymer or may be systematically included as a pendant. It may also be introduced into a part of the molecular structure of the additive such as an antioxidant, an acid scavenger and an ultraviolet light absorber.

Among the above ester plasticizer derived from a polycarboxylic acid and a monoalcohol, an alkyl dicarboxylic acid alkyl ester is preferable, specifically, a dioctyldiadipate of the above is cited.

As other plasticizers employable in the present invention, phosphate ester plasticizers, polymer plasticizers are cited. Phosphate ester plasticizer: Specific examples of the phosphate ester plasticizer include phosphoric acid alkyl esters such as triacetyl phosphate and tributyl phosphate; phosphoric acid cycloalkyl esters such as tricyclopentyl phosphate and cyclohexyl phosphate; and phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphtyl phosphate, trixylyl phosphate, trisortho-biphenyl phosphate. The substituent groups for these may be the same or different, and may be further substituted. The substituent groups may be a mix of an alkyl group, a cycloalkyl group and an aryl group, and the substituent groups may be bonded to each other via covalent bond.

Examples of the phosphoric acid ester also include phosphate esters, for example: alkylenebis(dialkylphosphate) such as ethylenebis(dimethylphosphate) or butylenebis(diethylphosphate); alkylenebis(diarylphosphate) such as ethylenebis(diphenylphosphate) or propylenebis(dinaphtylphosphate); arylenebis(dialkylphosphate) such as phenylenebis(dibutylphosphate) or biphenylenebis(dioctylphosphate); and arylenebis(diarylphosphates) such as phenylenebis(diphenylphosphate) or naphtylenebis(ditriylphosphate). These substituent groups may be the same or different, and may be further substituted. The substituent groups may be a mixture of an alkyl group, cycloalkyl groups and aryl groups, and the substituent groups may be bonded to each other via covalent bond.

Furthermore, a part of the structure of the phosphate ester may be a part of the polymer or may be systematically included as a pendant. It may also be introduced into a part of the molecular structure of the additive such as the antioxidant, the acid scavenger, the ultraviolet light absorber. Of the compounds listed above, aryl phosphate ester and arylenebis(diarylphosphate) are preferable, and more specifically, triphenyl phosphate and phenylenebis(diphenylphosphate) are preferable.

Polymer plasicizers: Specific examples of polymer plasticizs include: acryl polymers such as an aliphatic hydrocarbon polymer, an alicyclic hydrocarbon polymer, ethylpolyacrylate and poly(methylmethacrylate); vinyl polymers such as poly(vinylisobutylether) and poly(N-vinylpyrrolidone); styrene polymers such as polystyrene and poly(4-hydroxystyrene); polyesters such as polybutylenesuccinate, polyethylenetelephthalate and polyethylenenaphthalate; polyethers such as polyethyleneoxide and polypropyleneoxide; polyamide; polyurethane; and polyurea. The number average molecular weight of a polymer plasticizer is preferably 1, −500,000 and specifically preferably 5,000-200,000. The number average molecular weight of less than 1,000 may cause a problem of volatility and that of more than 500,000 may result in lowering of plastcizing ability which may cause an unfavorable effect on the physical property of the cellulose acylate film. These polymer plasticizers may be a homopolymer containing a single kind of repeat unit or a copolymer containing plural kinds of repeat units, or may contain 2 or more of the above polymers.

The adding amount of the other plasticizer is, in 100 weight parts of cellulose acylate, usually 0.1-50 weight parts, preferably 1-30 weight parts and still more preferably 3-15 weight parts.

In the optical film of the present invention, an additive having a similar effect as the above plasticizers may be added. For example, a low molecular weight organic compound having an effect of pasticizing a cellulose acylate film can provide a similar effect as a plasicizer. Such compound is not used to plasticize the film, however, it may exhibit the same effect as a plasticizer depending on the added amount.

### (Dye)

In order to optimize the color hue of the film, for example, a blue dye may be used as an additive. As a preferable dye, an anthraquinone type dye may be cited. An anthraquinone dye may have a substituent at any position of 1 to 8 positions of anthraquinone. Examples of a preferable substituents include: an aniline group which may be further substituted, a hydroxyl group, an amino group, a nitro group and a hydrogen atom. The adding amount of such a dye is preferably 0.1-1000 μg/m² and more preferably 10-100 μg/m².

### (Stabilizer)

In the cellulose acylate film of the present invention, one or more stabilizers selected from the group of: a phenol stabilizer, a hindered amine stabilizer, a phosphorus-containing stabilizer and a sulfur-containing stabilizer, may be added.

As a preferable phenol stabilizer, stabilizers known in the art can be used. Examples of a preferable stabilizer include: acrylate compounds disclosed in JP-A Nos. 63-179953 and 1-168643 such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenylacrylate; alkyl substituted phenol compounds such as octadecyl-3-(3,5-di-t-butyl-4-hydroxyphenyl)propionate, 2,2′-methylene-bis-(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene3-3-(3′,5′-di-t-butyl-4′-hydroxyphenylpropionate)methane) namely pentaerythrimethyl-tetrakis(3-(3,5-di-t-butyl-4-hydroxyphenylpropionate)), triethyleneglycol-bis(3-(3-t-butyl-4-hydroxy-5-methylphenyl)propionate); phenol compounds containing a triazine group such as 6-(4-hydroxy-3,-5-di-t-butylanilino)-2,4-bisoctylthio-1,3,5-triazine, 4-bisoctylthio-1,3,5-triazine and 2-octylthio-4,6-bis-(3,5-di-t-butyl-4-oxyanilino)-1,3,5-triazine.

Examples of a preferable hindered amine stabilizer include: bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(n-octoxy-2,2,6,6-tetramethyl-4-piperidyl)sebacate, bis(n-benzyloxy-2,2,6,6-tetramethyl-4-piperidyl)sebacate, bis(n-cyclohexyloxies-2,2,6,6-tetramethyl-4-piperidyl)sebacate, bis(1,2,2,6,6-pentamethyl-4-piperidyl)-2-(3,5-di-t-butyl-4-hydroxybenzyl)-2-butyl malonate, bis(1-bitter taste roil 2,2, and 6,6-tetra-methyl 4-piperidyl)2 and 2-bis(3,5-di-t-butyl 4-hydroxybenzyl)-2-butylmalonate, bis(1,2,2,6,6-pentamethyl-4-piperidyl)decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethyl piperidine, 2-methyl-2-(2,2,6,6-tetramethyl-4-piperidyl) amino-n-(2,2,6,6-tetramethyl-4-piperidyl)propione amide, tetrakis(2,2,6,6-tetra-methyl-4-piperidyl)-1,2,3,4-butanetetracarboxylate and tetrakis(1,2,2,6,6-pentamethyl-4-piperidyl)-1,2,3,4-butanetetracarboxylate.

As a phosphorus-containing stabilizer, commonly used stabilizers in resin industry are usable without any limitation. Examples of a preferable phosphorus-containing stabilizer include: monophosphite compounds such as triphenyl phosphite, diphenyl isodecyl phosphite, phenyl diisodecyl phosphite, tris(nonylphenyl)phosphite, tris(dinonylphenyl)phosphite, tris(2,4-di-t-butylphenyl)phosphite, 10-(3,5-di-t-butyl-4-hydroxybenzyl)-9,10-dihydro-9-oxa-10-phosphaphenanthrene-10-oxide; and diphosphite compounds such as 4,4,-butylidene-bis(3-methyl-6-t-butylphenyl-di-tridecyl phosphite) and 4,4′-isopropylidene-bis(phenyl-di-alkyl(C12-C15) phosphite). Of these, monophosphite compounds, specifically, tris(nonylphenyl)phosphite, tris(dinonylphenyl)phosphate and tris(2,4-di-t-butylphenyl)phosphite are preferable.

Examples of a preferable sulfur-containing stabilizer include: dilauryl-3,3-thiodipropionate, dimylistyl-3,3′-thiodipropionate, distearyl-3,3-thiodipropionate, laurylstearyl-3,3-thiodipropionate, pentaerythritol-tetrakis(β-lauryl)-thio-propionate and 3,9-bis(2-dodecylthioethyl)-2,4,8,10-tetraoxaspiro[5,5]undecane.

Example of these compounds will be given below, however, the present invention is not limited thereto.

IRGANOX 1010: produced by Ciba Specialty Chemicals Inc.

TINUVIN 770: produced by Ciba Specialty Chemicals Inc.

TINUVIN 144: produced by Ciba Specialty Chemicals Inc.

ADK STABLA LA-52: produced by ADEKA Corp.

Sumilezer GP: produced by Sumitomo Chemical Co., Ltd.

PEP-24 G: produced by ADEKA Corp.

Sumilezer TP-D: produced by Sumitomo Chemical Co., Ltd.

One or more of these stabilizers may be used in combination with the above mentioned phosphite esters. The used amount is arbitrary selected in the range not to lose the purpose of the present invention, however, the used amount is usually 0.001-10.0 weight parts, preferably 0.01-5.0 weight parts and more preferably 0.1-3.0 weight parts in 100 weight parts of cellulose acylate. The cellulose acylate of the present invention having a moisture content of 3.0 weight-% or less preferably includes one or more additives before the cellulose acylate is heat melted.

In the present invention, including the additive does not only refer to the additive being enclosed by the cellulose acylate, but also refers to the additive being present on the inside and the outer surface simultaneously.

The methods for including the additive include one in which the cellulose acylate is dissolved in a solvent, and then the additive is dissolved or dispersed in the resultant solution, and then the solvent is removed. Known methods are used to remove the solvent, and examples thereof include the liquid drying method, the air drying method, the solvent co-precipitation method, the freeze-drying method, and the solution casting method. The mixture of the cellulose acylate and the additive after the removal of the solvent can be prepared so as be in the form of particles, granules, pellets, a film or the like. The inclusion of the additive is performed by dissolving solid cellulose acylate as described above, but this may be performed simultaneously with deposition and solidification in the step of synthesizing the cellulose acylate.

An example of the liquid drying method is one in which an aqueous solution of an activating agent such as sodium lauryl sulfate is added to a solution in which the cellulose acylate and the acid are dissolved and an emulsion dispersion is performed. Next, the solvent is removed by normal pressure or low pressure distillation, and a dispersant of the cellulose acylate having the additive included therein is thereby obtained. In addition, centrifugal separation or decantation is preferably performed in order to remove the active agent. Various methods may be used as the emulsification method, and emulsification device using supersonic waves, high-speed rotational shearing and high pressure emulsification may be used.

In the emulsion dispersion method using ultrasonic waves, a so-called batch method and continuous method may be used. The batch method is suitable for preparation of comparatively small amounts of sample, while the continuous method is suitable for large amounts of sample. In the continuous method, a device such as the UH-600SR (manufactured by SMT Co., Ltd.) may be used. In the case of the continuous method, the amount of time for the irradiation of the supersonic waves can be determined by the capacity of the dispersion chamber/flow rate×circulation frequency. In the case where there is more than one supersonic irradiation device, the total of each irradiation time is determined. The irradiation time for the supersonic waves is not more than 10,000 seconds. Also, if the irradiation time needs to be greater than 10,000 seconds, the processing load becomes large, and the actual emulsion dispersion time must be made shorted be re-selecting the emulsifying agent or the like. As a result, a time exceeding 10,000 seconds is not necessary. It is more preferable that the time is between 10 and 2,000 seconds.

A disperser mixer, a homogenizer, an ultra mixer or the like may be used as the emulsion dispersion device which uses high-speed rotational shearing, and the viscosity of the liquid at the time of emulsion dispersion can determine which type of device is used.

For emulsion dispersion using high pressure, LAB 2000 (manufactured by SMT Co., Ltd.) may be used, but the emulsion dispersion capability depends on the pressure that is applied to the sample. Pressure in the range of 10⁴−5×10⁵ kPa is preferable.

Examples of the active agent that may be used include a cation surfactant, an anion surfactant, an amphoteric surfactant and a polymer dispersing agent. The active agent used is determined by the solvent and the particle diameter of the target emulsion.

The air drying method is one in which a spray dryer such as GS310 (manufactured by Yamato Scientific Co., Ltd.) is used, and a solution in which the cellulose acylate and the additive are dissolved is sprayed.

The solvent co-precipitation method is one in which a solution in which the cellulose acylate and the additive are dissolved is added to a poor solvent of the cellulose acylate and the additive and then precipitation takes place. The poor solvent may be optionally blended with the solvent which dissolves the cellulose acylate. The poor solvent may also be a mixed solvent. The poor solvent may also be added to a solution of the cellulose and the additive.

The mixture of the precipitated cellulose acylate and the additive can be filtered and dried to separate.

In the mixture of the cellulose acylate and the additive, the particle diameter of the additive is no greater than 1 μm and preferably no greater than 500 nm, and still more preferably no greater than 200 nm. The smaller the particle size of the additive, the more even the distribution of the mechanical strength and the optical properties of the melt cast, and thus a small particle size is favorable.

It is preferable that the mixture of the cellulose acylate and the additives as well as the additives added at the time of heat melting are dried prior to or during heat melting. Drying herein refers to removing the water adsorbed by any of the melting materials, in addition to either the water or solvent used preparing the cellulose acylate and additive mixture or the solvent introduced when preparing the additive.

The removal method may be any known drying method, and examples include the heating method, the pressure reduction method, the heating and pressure reduction method and the like, and may be performed in the air or in an inert gas environment with nitrogen selected as the inert gas. In view of film quality, it is preferable that these known drying methods are performed in a temperature range where the materials do not decompose.

For example, the moisture or solvent remaining after removal in the drying step is no greater than 10 weight % of the total weight of the materials comprising the film, and preferably no greater than 5 weight % and more preferably no greater than 1 weight %, and still more preferably no greater than 0.1 weight %. The drying temperature at this time is preferably between 100° C. and the Tg of the material to be dried. In view of preventing the materials from adhering to each other the drying temperature is preferably between 100° C. and the (Tg-5)° C. and more preferably between 110° C. and the (Tg-20)° C. The drying time is preferably 0.5-24 hours, and more preferably 1-18 hours and still more preferably 1.5-12 hours. If the drying time is less than these ranges, the level of drying will be low or the drying will take too much time. Also, if the material to be dried has a Tg, if it is heated to a drying temperature that is higher than Tg, the material melts and handling is difficult.

The drying stage may be separated into 2 or more stages. For example the melt film may be prepared via storage of the material using a preliminary drying step and a pre-drying step which is performed directly before to one week before the melt layer is prepared.

### (Matting Agent)

Particles are preferably added in the optical film of the present invention as a matting agent. Examples of inorganic particles employed in the present invention include: silicon dioxide, titanium dioxide, aluminium oxide, zirconium oxide, calcium carbonate, talc, clay, calcinated caolin, calcinated calcium silicate, hydrated calcium silicate, aluminium silicate, magnesium silicate and calcium phosphate.

The average diameter of primary particles of silicon dioxide is preferably 5-16 nm and more preferably 5-12 nm. A smaller average diameter of primary particles is preferable with respect to reducing haze. The apparent specific gravity of the particles is preferably 90-200 g/L (L representing liter) and more preferably 100-200 g/L. A larger apparent specific gravity is preferable since a dispersion of a higher content can be prepared resulting in reducing haze and agglomerate.

The additive amount of the matting agent is preferably 0.01-1.0 g/m², more preferably 0.03-0.3 g/m² and specifically preferably 0.10-0.18 g/m².

As silicon dioxide particles, for example AEROSIL R972, R972V, R974, R812, 200, 200V, 300, R202, OX50 and TT600 produced by Nippon Aerosil Co., Ltd., etc. are cited. Of these, AEROSIL 200V and R972V which are silicon dioxide particles having an average primary particle diameter of 20 nm or less and an apparent specific gravity of 70 g/L or more are specifically preferable since these particles lower the friction coefficient of the optical film while keeping a low level of haze.

As zirconium oxide particles, for example, product name of AEROSIL R976 and R811 (produced by Nippon Aerosil Co., Ltd.) have been commercialized and can be used. As polymer particles, particles of silicone resin, fluororesin and acryl resin can be cited. Of these, a silicone resin having a structure of three-dimensional network is specifically preferable. For example, product name of Tospal 103, 105, 108, 120, 145, 3120 and 240 (Toshiba Silicone Co., Ltd.) have been commercialized and can be used.

These particles preferably form secondary particles having an average diameter of 0.01-1.0 μm, more preferably 0.1-0.8 μm and most 0.2-0.5 μm. These particles exist in the film as aggregated primary particles and form irregularity of 0.01 to 1.0 μm on the surface of the optical film. The content of these particles is preferably 0.005-0.3% by weight, more preferably 0.05-0.2% by weight and most preferably 0.1-0.2% by weight based on the weight of the optical film.

### (Structure and Properties as an Optical Film)

In the optical film of the present invention, the orientation film may be formed and the liquid crystal layer may be provided thereon. In such a system, the retardation originating from the optical film and the liquid crystal layer are combined and optical compensation capability is imparted, and polarizing plate processing is thereby performed such that the quality of the liquid crystal display is improved. The compounds added for regulating retardation include aromatic compounds having 2 or more aromatic rings which are disclosed in, for example, European Patent No. 911,656A2 which can be used as retardation regulators. Two or more of these compounds may be used together. The aromatic ring of these aromatic compounds may include aromatic heterocyclic rings in addition to aromatic hydrocarbon rings. The aromatic heterocyclic ring is preferable and the aromatic heterocyclic ring is generally an unsaturated heterocyclic ring. Of these, 1,3,5-triazine ring is specifically preferable.

It is preferable that the dimensional stability of the optical film of the present invention is such that the dimensional variation is less than ±1.0% at 80° C. and 90% RH when the dimension of the film left for 24 hours at 23° C. and 55% RH is used as the reference. A variation of less than 0.5% is more preferable while less than 0.1% is specifically preferable.

Regarding the optical film of the present invention, used as a protective film for a polarizing plate, if the variation in the optical film itself exceeds the above range of dimensional stability, the absolute value of the retardation and the orientation angle of the polarizing plate may differ from that of the initial setting, which may result in reduced improvement in display quality, or deterioration of display quality.

The presence of additives in the materials composing the film, such as the cellulose acylate, plasticizer, antioxidant and others such as an ultraviolet light absorber, a matting agent and a retardation regulator which are added as appropriate, is favorable in view of preventing or controlling change in quality and deterioration of at least one of the materials comprising the film. Also, the additive itself is expected not to generate volatile component at the melting temperature of the film forming material.

The amount of a volatile component included in the film forming material when it is melted is preferably 1 weight % or less, more preferably 0.5 weight % or less, still more preferably 0.2 weight % or less and specifically more preferably 0.1 weight % or less. In the present invention, the differential thermal analysis-thermo gravimetry in the temperature range of 30° C. to 350° C. is carried out by a commercially available differential thermal analysis-thermogravimetric analyzer, TG/DTA 200 (manufactured by Seiko Instruments Inc.) to measure the weight loss in the film forming material, and the weight loss is considered as the amount of volatile component.

The refractive index of the optical film of the present invention may be controlled by appropriate stretching. By stretching the cellulose acylate film by a factor of 1.0-2.0 in one direction and by a factor of 1.01-2.5 in the perpendicular direction thereof in the film plane, the refractive index can be controlled within a desirable range.

For example, stretching can be done sequentially or simultaneously in the longitudinal direction of the film and perpendicular to that, or in other words the width direction. If at this time, the stretching factor in at least one direction is too small, only an insufficient retardation difference is obtained, while if it is too large, the stretching is difficult and breakage of the film sometimes occurs.

For example, in the case of stretching in the direction of casting after melting, if contraction in the width direction is too large, the refractive index in the thickness direction becomes too large. In this case, correction can be done by controlling the contraction in the width direction or by stretching in the width direction. In the case of stretching in the width direction, distribution of the refractive index in the width sometimes occurs. This is sometimes seen when the tenter method is used, but a contraction force is generated in the middle portion of the film by stretching in the width direction. This phenomenon occurs because the ends are fixed and is called the bowing phenomenon. In this case also, the bowing phenomenon can be controlled by stretching in the direction of casting, and distribution of the width direction phase difference is reduced to thereby achieve correction.

Furthermore, by stretching the film in the biaxial directions perpendicularly crossing each other, variation in film thickness can be reduced. If the variation in the thickness of the polarizing plate protective film is too large, there is unevenness in the phase difference and this poses a problem in terms of unevenness in coloration when used in a liquid crystal display.

The variation in the thickness of the cellulose acylate film support is preferably in the range of ±3%, and more preferably ±1%. A method of extrusion in the biaxial directions which cross each other is effective in order to achieve objects such as those above, and the stretching is performed such that the final stretch factor for the biaxial directions which cross each other is in the range of 1.0-2.0 for the casting direction, and 1.01-2.5 for the width direction, and preferably 1.01-1.5 for the casting direction, and 1.05-2.0 for the width direction.

In the case where a cellulose acylate is used which obtains positive birefringence with respect to stress, a slow axis for the optical film can be provided in the width direction by stretching in the width direction. In this case, it is preferable that the slow axis of the optical film is in the width direction in order to improve the display quality in the present invention, and the stretching factor in the width direction is preferably greater than stretching factor in the casting direction.

The method for stretching the web is not particularly limited. Examples include, a method in which a plurality of rolls are caused to have differing peripheral speeds and stretching is done in the vertical direction by utilizing the difference in peripheral speed between the rolls; a method in which both ends of the web are fixed with clips or pins and the spaces between the pins or clips are extended in the forward direction to thereby carry out stretching in both the vertical and horizontal directions; a method in which widening in the width direction and stretching in the width direction are performed simultaneously; and a method in which widening in the vertical direction and stretching in the vertical direction are performed simultaneously. As a matter of course, these and other methods may be used in combination. In addition, in the case of the so-called tenter method, smooth stretching can be carried out by driving the clip portion using a linear driving method, and this method is favorable because it reduces the risk of breakage and the like.

Maintaining the width or stretching the width in the horizontal direction in the process of preparing the film is preferably performed by a tenter, and may be performed by a pin tenter or a clip tenter.

In the case where the optical film of the present invention is used as a polarizing plate protective film, the thickness of the protective film is preferably 10-500 μm. In particular a thickness of 20 μm or more is preferable and 35 μm or more is more preferable. Also a thickness of 150 μm or less is preferable and 120 μm or less is more preferable. Particularly favorable is a thickness between 25 and 90 μM. If the optical film is thicker than 500 μm, the polarlizing plate becomes too thick after fabrication, and the thickness will be unsuitable for the liquid crystal displays used in notebook type personal computers and mobile electronic devices which, in particular, need to be thin and lightweight. On the other hand, if the optical film is thinner than 10 μm, sufficient retardation may not be obtained, and the water vapor permeability of the film may become high resulting in lowering the ability to protect the polarizer film against moisture.

When an optical film is used as a polarizing plate protective film, a UV absorber is preferably added. When a thinner optical film is used, a larger amount of UV absorber is needed to obtain enough UV absorbing effect. Accordingly, when a thinner optical film is used, bleeding out tends to occur due to a larger amount of UV absorber per unit thickness. In the present invention, bleeding out is effectively avoided, and a sufficient UV absorbing effect is obtained without bleeding out even when a thin polarizing plate protective film having a thickness of 35 to 65 μm is used.

The slow axis or the fast axis is present in the film plane and given that the angle formed in the direction of film formation is θ1, θ1 is preferably between −1° and +1°, and more preferably between −0.5° and +0.5°. θ1 can be defined as the orientation angle and can be measured using the automatic birefringence analyzer KOBRA-21ADH (manufactured by Oji Scientific Instruments).

If θ1 satisfies the above-described relationships, the displayed image will have a high luminance and this can contribute to the suppression or prevention of the escaping of light and thereby contribute to faithful color reproduction in the color liquid crystal display device.

### (Polymer Material)

Polymer materials and oligomers other than cellulose acylate may be suitably selected and mixed in the optical film of the present invention. The abovementioned polymer materials and oligomers preferably have excellent compatibility with cellulose acylate and the transparency when formed as a film is preferably 80% or more, more preferably 90% or more and still more preferably 92% or more. The purpose of mixing at least one or more of polymer materials and oligomers other than cellulose acylate is also to regulate viscosity during heat melting and to improve the physical properties of the film after film processing. In this case, additives other than those described above may be added.

For example, the mixture of the cellulose acylate and the additives of the present invention is subjected to hot air drying or vacuum drying and then subjected to melt extrusion, and then extruded as a film by using a T die. The film is then placed in contact with a cooling drum using an electrostatic method and cold fixing is performed to obtain an unstretched film. The temperature of the cooling drum is preferably maintained at 90-150° C.

The melt extrusion may be performed using a uniaxial extruder, a biaxial extruder, or using a biaxial extruder which has a uniaxial extruder connected downstream thereof, but it is preferable that the uniaxial extruder is used in view of the mechanical strength and optical properties of the resulting film. Also, it is preferable that the usual ambient air supplied to the raw material tank, the raw material charge section and the extruder interior and during the melting process is replaced with an inactive gas such as nitrogen, or that the pressure of the ambient air is reduced.

The temperature during melt extrusion of the present invention is typically to be in the range of 150-300° C., more preferably 180-270° C., but still more preferably 200-250° C.

It is particularly preferable that in the case where the optical film of the present invention is used as the polarizing plate protective film to form a polarizing plate, the cellulose acylate film is formed preferably by stretching in the width direction or in the longitudinal direction in regard.

The film is preferably peeled from the cooling drum and the resulting unstretched film is heated in the range from the glass transition temperature (Tg) of the cellulose acylate to Tg+100° C. via a heating device, such as a plurality of heated rollers and/or infrared ray heaters, and stretched in a single or a plurality of steps. Next, the obtained cellulose acylate film which is stretched in the longitudinal direction as described above, is preferably also stretched in the lateral direction in the range of Tg to Tg−20° C., after which the heat-fixing is conducted.

In the case of lateral stretching, if the stretching is done while sequentially heating the film at a stretch zone that is divided into more zones which have a temperature difference of 1-50° C., distribution of physical properties in the horizontal direction is reduced, which is favorable. Also, if after lateral stretching, the film is maintained for 0.01-5 minutes between the final lateral stretching temperature and Tg−40° C., the distribution of physical properties in the horizontal direction is further reduced which is also advantageous.

Heat-fixing is normally done within a range higher than the final lateral stretching temperature but not greater than Tg−20° C. for a period of 0.5-300 seconds. At that time, it is preferable that heat-fixing is done while sequentially increasing temperature in a stretch zone that is divided into two or more zones which have a temperature difference in the range of 1-100° C.

The film subjected to heat-fixing is usually cooled to a temperature less than the Tg, and the clip holding portion of both ends of the film is cut off and the film is wound up. At that time, it is preferable that a 0.1-10% relaxing process is performed in lateral and/or longitudinal direction at a range which is between the final heat-fixing temperature and the Tg. Also, cooling is preferably such that slow cooling from the final heat-fixing temperature to the Tg is achieved at a cooling rate not greater than 100° C. per second. The means for the slow cooling process is not particularly limited and can be performed by common known means, but it is particularly preferable to perform these processes while sequentially cooling in a plurality of temperature zones in view of improving the dimensional stability of the film. It is to be noted that, given that the final fixing temperature is T1 and the time for the film to reach Tg from the final heat-fixing temperature is “t”, the value for the cooling rate is determined by (T1−Tg)/t.

The optimal conditions for heat-fixing, cooling, and slow cooling processes differ depending on the cellulose acylate comprising the film, and thus are determined by measuring the physical properties of the biaxially stretched film, and suitably adjusting the conditions to obtain favorable properties.

### (Functional Layers)

When the optical film of the present invention is prepared, functional layers, for example, an antistatic layer, a hard coat layer, an anti-reflection layer, a matting layer, an adhesive layer, an anti-glare layer, a barrier layer and an optical compensation layer, may be provided prior to and/or after stretching. It is preferable that at least one layer selected from the anti-static layer, the hard coat layer, the anti-reflection layer, the adhesive layer, the antiglare layer and the optical compensation layer is provided. At that time, various surface treatments, for example, a corona discharge treatment, plasma treatment and chemical treatment may also be carried out, if necessary.

In the present invention, a laminated cellulose acylate film may be formed by co-extruding cellulose acylate compositions containing different kinds of cellulose acylates, different kinds of additives or different amounts of additives.

For example, a cellulose acylate film can be made so as to have the structure of a skin layer/core layer/skin layer. A matting agent may be provided in a large amount in the skin layers or alternatively, may be only in the skin layer. A melt extruded layer of cellulose diacetate which can be easily saponified may be formed as a skin layer. The melt extrusion of cellulose diacetate can be carried out using a known method in the art. The plasticizer and the ultraviolet light absorber may be provided in a larger amount in the core layer than in the outermost layer, or may be only in the core layer. The types of plasticizers and ultraviolet light absorbers in the core layer and the skin may be changed and a low volatility plasticizer and/or an ultraviolet light absorber may be added to the skin layer, while a plasticizer with excellent plasticity or an ultraviolet light absorber with excellent ultraviolet light absorbing properties may be added to the core layer. The Tg of the skin layer and the core layer may be different, and it is preferably that the Tg of the core layer is lower than that of a skin layer. Further, the viscosity of the melt including the cellulose acylate at the time of melt casting may differ in the skin layer and the core layer, and the viscosity of the skin layer may be greater than the viscosity of the core layer, or the viscosity of the core layer may be greater than or equal to the viscosity of a skin layer. A laminated film having uniform thickness may be obtained when the melt of a thinner layer (usually the skin layer) has a higher viscosity.

### (Polarizing Plate and Liquid Crystal Display)

When the cellulose acylate film of the present invention is used as a protective film of a polarizing plate to be utilized in a liquid crystal display, it is preferable that the polarizing plate of the present invention is used on at least one surface of the liquid crystal cell, and more preferable is that the polarizing plates of the present invention are used on both surfaces of the liquid crystal cell.

As a conventional polarizing plate protective film, cellulose acylate films of Konica Minolta TAC: KC8UX, KC4UX, KC5UX, KC8UY, KC4UY, KC8UCR-3, KC8UCR-4, KC12UR, KC8UXW-H, KC8UYW-HA, and KC8UX-RHA (produced by Konica Minolta Opto, Inc.), have been used.

The method to produce the polarizing plate of the present invention is not specifically limited and generally known methods are applicable. Obtained polarizing plate protective film of the present invention may be treated with an alkali solution and may be adhered on both surfaces of a polarizer film using an aqueous solution of fully saponified polyvinyl alcohol. The polarizer film can be prepared by immersing a polyvinyl alcohol film in an aqueous solution containing iodine, followed by stretching. This method is favorable because the polarizing plate protective film of the present invention can be directly adhered on at least one surface of a polarizer film.

Instead of the alkali treatment described above, an adhesive treatment, for example, disclosed in JP-A Nos. 6-94915 and 6-118232 may be carried out.

A polarizing plate contains a polarizer film and protective films which protect the both surfaces of the polarizer film. It is also preferable to constitute a polarizing plate by adhering a surface protective film on one surface of the polarizing plate and a separate film on the reverse surface. The surface protective film and the separate film are employed to protect the polarizing plate at its shipping and product inspection. In this case, the surface protective film is adhered to protect the surface of the polarizing plate on the surface reverse to the surface which is adhered to a liquid crystal cell. On the other hand, the separate film is employed to cover the adhesion layer to adhere the polarizing plate to a liquid crystal cell.

In a liquid crystal display, usually a substrate containing a liquid crystal cell is placed between two polarizing plates. Since the polarizing plate protective film prepared by using the optical film of the present invention exhibits high dimensional stability, an excellent display performance is obtained even when the polarizing plate protective film of the present invention is used in any portion of the liquid crystal display. On an outermost surface of the viewer side surface of a liquid crystal display, a polarizing plate protective film provided with, for example, a clear hard coat layer, an antistatic layer and an antireflection layer, is preferably employed. When a polarizing plate protective film is provided with an optical compensation layer or the film itself has a function of optical compensation by a stretching treatment, an excellent display performance is obtained by using the polarizing plate protective film in contact with the liquid crystal cell. The effect of the present invention is more markedly obtained by using the polarizing plate protective film of the present invention in a multi-domain mode liquid crystal display, more preferably in a multi-domain mode liquid crystal display of a birefringence mode.

The multi-domain mode refers to a method in which a pixel is divided into plural domains, and it is suitable for improving viewing angle dependency of images or symmetry of displayed images. On this mode, various methods have been reported, for example, in “Okita and Yamauchi, Liquid Crystal, 6(3), p 303 (2002)”; and, on multi-domain mode liquid crystal display, for example, in “Yamada and Yamahara, LIQUID CRYSTAL, 7(2), p 184 (2003)”, however, the present invention is not limited thereto.

The quality of the image is preferably symmetry when observed by a viewer. Accordingly, when the display is a liquid crystal display, multi-domaining of pixels is carried out in order to improve the symmetry on the viewing side of the display. The method for multi-domaining can be selected from those known in the art by considering the nature of liquid crystal mode, and, also, depending on binary or quaternary dividing of the pixel.

The present invention may be effectively employed in the liquid crystal displays of the following modes, for example: (i) a MVA (Multi-domain Vertical Alignment) mode which is one of typical examples of the vertical alignment mode, specifically a 4-domain MVA mode; (ii) a PVA (Patterned Vertical Alignment) mode which is multi-domained by patterned electrodes; and (iii)a CPA (Continuous Pinwheel Alignment) mode in which a Chiral force and patterned electrodes are merged. Use of an optically biaxial film in an OCB (Optically Compensated Bend) mode has been proposed in “T. Miyashita, T. Uchida, J. SID, 3(1), 29 (1995)” in which the polarizing plate of the present invention may be employed to exhibit the effect of the present invention. The order of stacking of polarizing plates and the type of liquid crystal mode is not limited, provided that the effect of the present invention is obtained by using the polarizing plate of the present invention.

Since the liquid crystal display exhibits high performance as an apparatus for displaying color images and moving pictures, the liquid crystal display, specifically a large-screen liquid crystal display, using the optical film of the present invention enables to provide faithful moving pictures without giving eye fatigue.

### SYNTHESIS EXAMPLE 1

The synthesis method of the polymer compound derived from the monomer represented by Formula 1 is described below but the present invention is not limited thereto.

### SYNTHESIS EXAMPLE 1 (SYNTHESIS OF P-1)

To 75 ml of chloroform, 5.25 g of M-1, 7.5 g of methyl methacrylate and 2.25 g of 2-hydroxyethyl methacrylate were added, and then 9.03 g of 2,2′-azo-bis(4-methoxy-2,4-dimethylveleronitrile) was further added. The resultant solution was stirred for 8 hours at 45° C. under nitrogen atmosphere. The reacting liquid was cooled by standing and dropped into 2 liters of hexane. Precipitated substance was separated by filtration and dried at 40° C. under vacuum. Thus 12 g of slightly yellowish fine powder of copolymer P-1 was obtained. It was confirmed by GPC analysis using standard polystyrene that the weight average molecular weight of the copolymer was 2,400. Moreover, it was confirmed that the copolymer had a ratio of M-1:methyl methacrylate:2-hydroxyethyl methacrylate of about 35:50:15, wherein the ratio means the weight ratio, in the present examples.

### SYNTHESIS EXAMPLE 2 (SYNTHESIS OF P-2)

To 75 ml of chloroform, 5.25 g of M-1, 7.5 g of methyl methacrylate and 2.25 g of 2-hydroxyethyl methacrylate were added, and then 5.15 g of 2,2′-azo-bis-isobutylnitrile was further added. The resultant solution was stirred for 8 hours at 70° C. under nitrogen atmosphere. The reacting liquid was cooled by standing and dropped into 2 liters of hexane. Precipitated substance was separated by filtration and dried at 40° C. under vacuum. Thus 14.7 g of slightly yellowish fine powder of copolymer P-2 was obtained. It was confirmed by GPC analysis using standard polystyrene that the weight average molecular weight of the copolymer was 4,200. Moreover, it was confirmed that the copolymer had composing ratio of M-1:methyl methacrylate:2-hydroxyethyl methacrylate of about 35:50:15.

### SYNTHESIS EXAMPLE 3 (SYNTHESIS OF P-3)

To 30 ml of chloroform, 3.0 g of M-1, 2.31 g of methyl methacrylate and 0.69 g of 2-hydroxyethyl methacrylate were added, and then 3.28 g of 2,2′-azo-bis(4-methoxy-2,4-dimethylveleronitrile) was further added. The resultant solution was stirred for 8 hours at 45-C under nitrogen atmosphere. The reacting liquid was cooled by standing and dropped into 1 liter of hexane. Precipitated substance was separated by filtration and dried at 40° C. under vacuum. Thus 3.8 g of slightly yellowish fine powder of copolymer P-3 was obtained. It was confirmed by GPC analysis using standard polystyrene that the weight average molecular weight of the copolymer was 2,600. Moreover, it was confirmed that the copolymer had composing ratio of M-1:methyl methacrylate:2-hydroxyethyl methacrylate of about 50:38.5:11.5.

### SYNTHESIS EXAMPLE 4 (SYNTHESIS OF P-4)

To 30 ml of chloroform, 4.2 g of M-1, 1.38 g of methyl methacrylate and 0.42 g of 2-hydroxyethyl methacrylate were added, and then 2.5 g of 2,2′-azo-bis(4-methoxy-2,4-dimethylveleronitrile) was further added. The resultant solution was stirred for 8 hours at 45° C. under nitrogen atmosphere. The reacting liquid was cooled by standing and dropped into 1 liter of hexane. Precipitated substance was separated by filtration and dried at 40° C. under vacuum. Thus 4.1 g of slightly yellowish fine powder of copolymer P-4 was obtained. It was confirmed by GPC analysis using standard polystyrene that the weight average molecular weight of the copolymer was 2,600. Moreover, it was confirmed that the copolymer had composing ratio of M-1:methyl methacrylate:2-hydroxyethyl methacrylate of about 70:23:7.

P-5 through P-17 were each synthesized by receipts similar to that in the above. Polymers derived from monomers represented by Formula 1 can be synthesis in the similar manner.

P-5: A copolymer having a weight average molecular weight of 3,000 and a ratio of M-10:methyl acrylate of about 50:50

P-6: A copolymer having a weight average molecular weight of 2,800 and a ratio of M-10:methyl acrylate:2-hydroxyethyl acrylate of about 35:50:15

P-7: A copolymer having a weight average molecular weight of 4,500 and a ratio of M-15:ethyl methacrylate:ethyl vinyl ether of about 50:40:10

P-8: A copolymer having a weight average molecular weight of 5,800 and a ratio of M-15:methyl acrylate:2-hydroxyethyl acrylate of about 70:10:20

P-9: A copolymer having a weight average molecular weight of 6,800 and a ratio of M-15:vinyl acetate:metyl acrylate of about 20:30:50

P-10: A copolymer having a weight average molecular weight of 2,000 and a ratio of M-16:methyl methacrylate: 2-hydroxyethyl methacrylate of about 35:50:15

P-11: A copolymer having a weight average molecular weight of 3,500 and a ratio of M-16:glycidyl methacrylate: methyl methacrylate of about 45:10:45

P-12: A copolymer having a weight average molecular weight of 2,100 and a ratio of M-21:α-methylstyrene: methyl methacrylate of about 35:10:55

P-13: A copolymer having a weight average molecular weight of 1,200 and a ratio of M-21:methyl acrylate: 2-hydroxyethyl acrylate of about 50:38.5:11.5

P-14: A copolymer having a weight average molecular weight of 3,100 and a ratio of M-28:methyl acrylate: 2-hydroxyethyl acrylate of about 30:50:20

P-15: A copolymer having a weight average molecular weight of 3,500 and a ratio of M-28:methyl methacrylate: 2-hydroxyethyl methacrylate of about 60:30:10

P-16: A copolymer having a weight average molecular weight of 10,000 and a ratio of M-1:methyl methacrylate: 2-hydroxyethyl methacrylate of about 35:50:15

P-17: A copolymer having a weight average molecular weight of 19,500 and a ratio of M-1:methyl acrylate: 2-hydroxyethyl acrylate of about 35:50:15

### SYNTHESIS EXAMPLE 2

Synthesis method of the cellulose acylate of the present invention is described in detail bellow but the present invention is not limited thereto.

Cellulose Acylate

### SYNTHESIS EXAMPLE 1

To 30 g of cellulose dissolved pulp manufactured by Nihon Seishi Co., Ltd., 540 g of acetic acid was added and stirred at 54° C. for 30 minutes. The mixture was cooled and 150 g of acetic anhydride and 1.2 g of sulfuric acid cooled in an ice water bath were added and esterification reaction was carried out. In the esterification reaction, the reacting mixture was stirred for 150 minutes while controlling the temperature so as not to over 40° C. After completion of the reaction, a mixture of 30 g of acetic acid and 10 g of water was dropped spending for 20 minutes for hydrolyzing excessive anhydride. Ninety grams of acetic acid and 30 g of water was added and stirred for 1 hour while holding the temperature at 40° C. The mixture was poured into an aqueous solution containing 2 grams of magnesium acetate and stirred for some times. Resultant precipitate was filtered and dried to obtain cellulose acylate C-1. Acetyl substitution degree and weight average molecular weight were each 2.80 and 220,000, respectively.

### SYNTHESIS EXAMPLES 2 to 8

Cellulose acylates C-2 to C-8 were obtained in the same operation as in synthesis examples 1 except that acetic acid, acetic anhydride, propionic acid, butylic acid and butylic anhydride were used as shown in Table 1.

TABLE 1

| | | | | | | | | Total | | |
|---|---|---|---|---|---|---|---|---|---|---|
| | Acyl group | | | | | Fatty | | carbon | | |
| | substitution | | | Fatty | | acid | | number | | |
| | degree | | | acid | | anhydride | | of acyl | | |
| | Ac | Pr | Bu | I | II | I | II | group | Mw | Remarks |
| C-1 | 2.80 | 0.00 | — | 30 | 0 | 150 | 0 | 5.60 | 220000 | Comparative |
| C-2 | 2.45 | 0.43 | — | 87 | 20 | 51 | 50 | 6.20 | 211000 | Inventive |
| C-3 | 0.65 | 1.73 | — | 10 | 100 | 10 | 100 | 6.50 | 201000 | Inventive |
| C-4 | 2.20 | — | 0.63 | 87 | 20 | 43 | 62 | 6.90 | 198000 | Inventive |
| C-5 | 1.65 | 1.27 | — | 90 | 20 | 8 | 125 | 7.10 | 238000 | Inventive |
| C-6 | 1.45 | 1.43 | — | 70 | 40 | 8 | 125 | 7.20 | 241000 | Inventive |
| C-7 | 0.35 | 2.20 | — | 20 | 90 | 9 | 124 | 7.30 | 223000 | Inventive |
| C-8 | 0.15 | 2.73 | — | 0 | 90 | 4 | 125 | 8.50 | 248000 | Comparative |

Acyl group substitution degree/Ac: Acetyl group, Pr: Propionyl group, Bu: Butylyl group
Fatty acid/I: Acetic acid, II: Propionic acid or butylic acid
Fatty acid anhydride/I: Acetic anhydride, II: Propionic anhydride or n-butylic anhydride
Mw: Weight average molecular weight (The weight average molecular weight was measured by GPC HLC-8220 manufactured by Tosoh Corp.)

### SYNTHESIS EXAMPLES 9 to 41

Cellulose acylates C-9 to C-25 were obtained in the same manner as in Synthesis example 1 except that the fatty acids and fatty acid anhydrides corresponding to the substitution degrees described in Table 2 were used.

TABLE 2

| | Acyl group substitution | | | | Total carbon | |
|---|---|---|---|---|---|---|
| | degree | | | | number of | |
| | Ac | Pr | Bu | Pe | acyl group | Remarks |
| C-9 | 0.85 | 1.42 | | | 5.95 | Comparative |
| C-10 | 2.65 | 0.23 | | | 6.00 | Comparative |
| C-11 | 0.95 | 1.43 | | | 6.20 | Inventive |
| C-12 | 2.00 | | | 0.44 | 6.20 | Inventive |
| C-13 | 1.25 | 1.27 | | | 6.30 | Inventive |
| C-14 | 2.10 | | 0.55 | | 6.40 | Inventive |
| C-15 | 1.75 | 1.00 | | | 6.50 | Inventive |
| C-16 | 0.35 | 2.03 | | | 6.80 | Inventive |
| C-17 | 1.35 | 1.37 | | | 6.80 | Inventive |
| C-18 | 0.65 | 1.90 | | | 7.00 | Inventive |
| C-19 | 2.20 | | 0.68 | | 7.10 | Inventive |
| C-20 | 0.95 | 1.77 | | | 7.20 | Inventive |
| C-21 | 1.05 | 1.73 | | | 7.30 | Inventive |
| C-22 | 0.25 | 2.33 | | | 7.50 | Inventive |
| C-23 | 2.10 | | | 0.66 | 7.50 | Inventive |
| C-24 | 0.10 | 2.60 | | | 8.00 | Comparative |
| C-25 | 1.20 | | 1.65 | | 9.00 | Comparative |

### EXAMPLES

Embodiments of the present invention are concretely described referring examples below but the present invention is not limited thereto. In the following examples, “part” represents “part by weight.

### Example 1

(Preparation of Cellulose Acylate Film)

<Film F-1>

One hundred parts of Cellulose Acylate C-1, 1.0 part of Stabilizer A-1, 1.2 part of UV absorbent: Comparative Compound 1 and 0.3 part of matting agent: Aerogil R972V were mixed and dried at 90° C. for 5 hours under reduced pressure, and then 15 parts of plasticizer TPP was added and mixed. Thus obtained cellulose acylate composition was melted by a melt-extrusion machine under nitrogen atmosphere at a melting temperature of 260° C. and a screw rotating rate of 200 rpm. However, the composition was difficultly melted and could not be formed to film.

<Films F-2 to F-32>

Films F-2 to F-32 were prepared in the same manner as F-1 except that 100 parts of the cellulose acylates listed in Table 3, 15 parts of the plasticizers, 1.0 part of Stabilizers-1, 1.0 part of Stabilizers-2, UV absorbents and 0.3 part of matting agent: Aerogil 972V were used at the temperatures given in Table 3. The extruding amount and receiving speed were controlled so that the film thickness was to be 80 μm.

### (Plasticizer)

TPP: Triphenyl phosphate

TMP: Trimethylolpropane tribezoate

PETB: Pentaerythrytol tetrabenzoate

### (Stabilizer)

A-1: Irganox-1010 (Ciba Specialty Chemicals Co. Ltd.)

A-2: Tinuvin 144 (Ciba Specialty Chemicals Co. Ltd.)

A-3: Sumilizer GP (Sumitomo Kagaku Kogyo Co., Ltd.)

A-4: LA-52 (produced by ADEKA Corp.

TABLE 3

| | | | | | | | Film | |
|---|---|---|---|---|---|---|---|---|
| | Cellulose | UV | | | | | forming | |
| | acylate | absorbent | *1 | * | Stabilizer-1 | Stabilizer-2 | temperature | Remarks |
| F-1 | C-1 | **1 | 1.2 | TPP | A-1 | — | 260 | Comp. |
| F-2 | C-3 | P-1 | 2.7 | TMP | A-2 | — | 260 | Inv. |
| F-3 | C-4 | P-2 | 2.7 | PETB | A-1 | A-4 | 260 | Inv. |
| F-4 | C-4 | P-5 | 1.5 | TMP | A-1 | A-3 | 260 | Inv. |
| F-5 | C-5 | P-3 | 1.8 | TMP | A-1 | A-4 | 250 | Inv. |
| F-6 | C-5 | P-6 | 2.7 | PETB | A-2 | — | 250 | Inv. |
| F-7 | C-6 | P-4 | 1.5 | PETB | A-1 | A-3 | 240 | Inv. |
| F-8 | C-6 | P-7 | 1.8 | TPP | A-1 | A-4 | 240 | Inv. |
| F-9 | C-7 | P-5 | 1.8 | TPP | A-1 | A-4 | 230 | Inv. |
| F-10 | C-8 | P-6 | 2.7 | TPP | A-1 | — | 230 | Comp. |
| F-11 | C-9 | P-7 | 1.8 | PETB | A-2 | — | 270 | Comp. |
| F-12 | C-10 | P-8 | 1.4 | TPP | A-1 | A-3 | 260 | Comp. |
| F-13 | C-10 | P-9 | 4.1 | PETB | A-1 | A-4 | 270 | Comp. |
| F-14 | C-11 | P-10 | 2.8 | TMP | A-2 | — | 260 | Inv. |
| F-15 | C-12 | P-11 | 1.9 | TPP | A-1 | — | 260 | Inv. |
| F-16 | C-13 | P-12 | 2.6 | TMP | A-1 | A-3 | 250 | Inv. |
| F-17 | C-14 | P-13 | 1.8 | TMP | A-1 | A-3 | 260 | Inv. |
| F-18 | C-15 | P-14 | 3.0 | PETB | A-1 | A-4 | 260 | Inv. |
| F-19 | C-16 | P-1 | 2.7 | PETB | A-2 | — | 250 | Inv. |
| F-20 | C-16 | P-8 | 1.4 | TMP | A-1 | A-4 | 250 | Inv. |
| F-21 | C-17 | P-3 | 1.8 | TMP | A-1 | A-4 | 260 | Inv. |
| F-22 | C-17 | P-9 | 4.1 | PETB | A-2 | — | 260 | Inv. |
| F-23 | C-18 | P-3 | 1.8 | TMP | A-1 | A-3 | 250 | Inv. |
| F-24 | C-18 | P-2 | 2.7 | PETB | A-1 | A-4 | 250 | Inv. |
| F-25 | C-19 | P-4 | 1.5 | TPP | A-1 | A-4 | 240 | Inv. |
| F-26 | C-21 | **1 | 1.2 | PETB | A-1 | — | 240 | Comp. |
| F-27 | C-22 | P-1 | 2.7 | TMP | A-2 | — | 230 | Inv. |
| F-28 | C-23 | P-3 | 1.8 | TMP | A-1 | A-2 | 240 | Inv. |
| F-29 | C-24 | P-4 | 1.5 | PETB | A-1 | — | 220 | Comp. |
| F-30 | C-25 | P-15 | 1.7 | TMP | A-1 | — | 220 | Comp. |
| F-31 | C-3 | P-16 | 2.2 | TMP | A-1 | A-3 | 250 | Inv. |
| F-32 | C-4 | P-17 | 2.0 | TMP | A-1 | — | 250 | Inv. |

**Comparative compound,
* Plasticizer
*1: Adding amount of UV absorbent (Part by weight)
Inv.: Inventive,
Comp.: Comparative

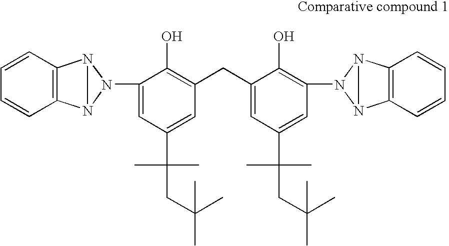

Samples F-1 to F-32 prepared as above were subjected to the following evaluation.

(Evaluation of UV Absorbing Ability)

Absorption spectrum of each of the optical films was measured by a spectrophotometer U-3200 manufactured by Hitachi Seisakusho Co., Ltd., and transmittance at 400 nm and that at 380 nm were determined. The samples were classified into the following ranks according to the above transmittance values. In each of the ranks, higher transmittance at 400 nm and lower transmittance at 380 nm are respectively evaluated as better.

### (Transmittance at 400 nm)

A: The transmittance was not less than 80%

B: The transmittance was not less than 70% and less than 80%

C: The transmittance was not less than 60% and less than 70%

D: The transmittance was less than 60%

### (Transmittance at 380 nm)

A: The transmittance was less than 5%

B: The transmittance was not less than 5% and less than 8%

C: The transmittance was not less than 8% and less than 10%

D: The transmittance was not less than 10%

(Durability: Evaluation of Bleeding Out)

Each of the optical films were stood for 1,000 hours under high temperature and humidity condition of 80° C. and 90% RH and occurrence of bleeding out (separating out of crystals) at the surface of the optical film was visually observed, and evaluated according to the following norms.

A: Occurrence of bleed out was not observed at all on the film surface.

B: Bleed out was slightly observed a part of the optical film.

C: Bleed out was observed a little on the entire surface of the optical film.

D: Bleed out was clearly observed on the entire surface of the optical film.

(Evaluation of Retardation Value)

A sample of square of 200 mm was cut out from each of the above prepared cellulose acylate films and refractive indexes Nx, Ny and Nz at a wave length of 590 nm were determined by a pitch of 5 mm using an automatic double refractometer KOBRA 21 ADH, manufactured by Ooji Keisokuki Co., Ltd., under a condition of 23° C. and 55% RH. Retardation value Ro₅₅ of in-plane direction and retardation value Rt₅₅ of thickness direction were determined according to the following expressions.

Ro=(Nx−Ny)×d

Rt={(Nx+Ny)/2−Nz}×d

In the above, Nx is in-plane refractive index in the slow axis direction Ny is in-plane refractive index in the fast axis, Nz is thickness direction refractive index and d is thickness (nm) of the film.

Next, the sample was stood for 3 hours under a condition of 23° C. and 80% RH and retardation values Ro₈₀ and Rt₈₀ were determined in the same manner as above. The absolute value of difference between the Ro₅₅ and Ro₈₀ (ΔRo) and the absolute value of different between Rt₅₅ and Rt₈₀ (ΔRt) were calculated.

ΔRo=|Ro₈₀−Ro₅₅|ΔRt=|Rt₈₀−Rt₅₅|

(Evaluation of Haze)

Haze of the sample was measured by a haze meter 1001DP, manufactured by Nihon Denshoku Kogyo Co., Ltd., and the result was expressed in terms of thickness of the film of 80 μm. The evaluation was carried out according to the following norms.

A: The haze value was less than 0.5%.

B: The haze value was not less than 0.5% and less than 1.0%.

C: The haze value was not less than 1.0% and less than 1.5%.

D: The haze value was not less than 1.5%.

(Evaluation of Light-Resistance)

Each of the optical films was subjected to an alkali saponification treatment according to the following processes and a polarizing plates were prepared by using each of the treated optical film. Parallel direction transmittance H₀ and crossed direction transmittance H₉₀ of the polarizing plate and polarization degree was calculated by the following expression. After that, each of the polarizing plates were subjected to an accelerated aging test for 500 hours in a sunshine weather-meter with no UV filter, and then parallel direction transmittance H₀′ and crossed direction transmittance H₉₀′ were measured and polarization degree P₀ and P₅₀₀ were calculated by the following expressions. The variation in the polarization degree was determined by the following expressions.

(Alkali Saponification Treatment)

| | | | |
|---|---|---|---|
| Saponification process: | 2 moles/L NaOH | 50° C. | 90 sec. |
| Washing process: | Water | 30° C. | 45 sec. |
| Neutralization process: | 10 wt-% HCl | 30° C. | 45 sec. |
| Washing process: | Water | 30° C. | 45 sec. |

Samples were each processed in the order of the saponification, washing, neutralization and washing and dried at 80° C.

(Preparation of Polarizing Plate)

Poly(vinyl alcohol) film of thickness of 120 μm was immersed into 100 kg of a solution containing 1 kg of iodine and 4 kg of boric acid and stretched by 6 times at 50° C. to prepare a polarizing film. The alkali saponified sample was pasted on both sides of the polarizing film using a 5% aqueous solution of completely saponified poly(vinyl alcohol) as an adhesive to prepare a polarizing plate.

(Calculation of Polarization Degrees P₀ and P₅₀₀)

Polarization degree P₀=[(H₀−H₉₀)/(H₀+H₉₀)]/2×100

Polarization degree P₅₀₀=[(H₀′−H₉₀′)/(H₀′+H₉₀′)]/2×100

Variation of polarization degree=P₀−P₅₀₀

In the above, P₀ is the polarization degree before the accelerated aging treatment and P₅₀₀ is the polarization degree after accelerated aging treatment for 500 hours.

Ranking norms of light-resistance

The variation of polarization degree obtained as above was ranked according to the following norms for evaluating the light-resistance.

A: The variation of polarization degree was less than 10%

B: The variation of polarization degree was not less than 10% and less than 25%

C: The variation of polarization degree was not less than 25%

Thus obtained results are listed in Table 4.

TABLE 4

| | UV absorbing | | | | | | | |
|---|---|---|---|---|---|---|---|---|
| | ability | | | Retardation | | | | |
| Film | **400 | **380 | Bleeding | value | | | | Re- |
| No. | nm | nm | out | ΔR0 | ΔRt | Haze | *1 | marks |
| F-1 | A | A | — | — | — | — | — | Comp. |
| F-2 | A | A | A | 1 | 9 | A | A | Inv |
| F-3 | A | A | A | 2 | 12 | A | A | Inv. |
| F-4 | A | A | A | 3 | 13 | A | A | Inv. |
| F-5 | A | A | A | 1 | 10 | A | A | Inv. |
| F-6 | A | A | A | 2 | 11 | A | A | Inv. |
| F-7 | A | A | A | 4 | 13 | A | A | Inv. |
| F-8 | A | A | A | 6 | 14 | A | A | Inv. |
| F-9 | A | A | A | 5 | 15 | A | A | Inv. |
| F-10 | A | A | A | 10 | 42 | C | A | Comp. |
| F-11 | A | A | A | 12 | 45 | C | A | Comp. |
| F-12 | A | A | A | 10 | 51 | C | A | Comp. |
| F-13 | A | A | A | 11 | 48 | C | A | Comp. |
| F-14 | A | A | A | 3 | 15 | A | A | Inv. |
| F-15 | A | A | A | 2 | 17 | A | A | Inv. |
| F-16 | A | A | A | 2 | 16 | A | A | Inv. |
| F-17 | A | A | A | 4 | 20 | A | A | Inv. |
| F-18 | A | A | A | 4 | 17 | A | A | Inv. |
| F-19 | A | A | A | 2 | 12 | A | A | Inv. |
| F-20 | A | A | A | 6 | 11 | A | A | Inv. |
| F-21 | A | A | A | 1 | 11 | A | A | Inv. |
| F-22 | A | A | A | 4 | 14 | A | A | Inv. |
| F-23 | A | A | A | 1 | 13 | A | A | Inv. |
| F-24 | A | A | A | 3 | 12 | A | A | Inv. |
| F-25 | A | A | A | 4 | 12 | A | A | Inv. |
| F-26 | A | A | D | 8 | 41 | C | B | Comp. |
| F-27 | A | A | A | 3 | 17 | A | A | Inv. |
| F-28 | A | A | A | 2 | 13 | A | A | Inv. |
| F-29 | A | A | A | 12 | 46 | C | A | Comp. |
| F-30 | A | A | A | 10 | 50 | C | A | Comp. |
| F-31 | A | A | A | 3 | 20 | B | A | Inv. |
| F-32 | A | A | A | 5 | 22 | B | A | Inv. |

Comp.: Comparative,
Inv.: Inventive,
**Transmittance at
*1: Light-resistance

As is cleared from Table 4, it is understood that the optical films using UV absorbent of the present invention and cellulose acylate of the present invention are superior to the comparative examples in the UV absorbing ability, haze, light-resistance and humidity dependency of retardation.

The optical films of the present invention having thicknesses of 40 μm and 60 μm were also prepared each of which containing the same amount of the polymer derived from the monomer represented by Formula 1. It was found that sufficient UV absorbing properties were observed on these optical films and no bleeding out of the polymer was observed. Also, the same excellent results were obtained with respect to the retardation values, haze and light-resistance. In the cases of thinner films, for example, having thicknesses of 40 and 60 μm, a larger amount of UV absorbent per unit thickness is needed to attain the same UV absorbing effect as that of an optical of a thickness of 80 μm. However, according to the structure of the present invention, thinner films exhibiting excellent properties were obtained.

### Example 2

From a portable apparatus, personal mobile tool Zaurus MI-L1 manufactured by Sharp Co., Ltd., the polarizing plate was carefully peeled off and each of the polarizing plates prepared in Example 1 was pasted on that place so as to agree the polarizing direction. Contrast of the images displayed on each of the panel was visually evaluated. As a result of that, it was confirmed that the liquid crystal displaying panels using the polarizing plate held high contrast for long period and superior in color reproducibility without unnatural yellowish coloring compared with the liquid panel using the polarizing plates of the comparative examples.

What is claimed is:

1. A cellulose acylate optical film comprising a polymer derived from at least a monomer represented by Formula 1 and a cellulose acylate having an acyl group of 3 or more carbon atoms, wherein
a total number of carbon atoms contained in the acyl groups in one glucose unit of the cellulose acylate is larger than 6.0 and not larger than 7.5, wherein the total number of carbon atoms represents a sum of each product of a number of carbon atoms of each acyl group and a substitution degree of the acyl group, wherein the substitution degree represents an average number of 3 hydroxyl groups replaced with an acyl group in one glucose unit of the cellulose acylate: 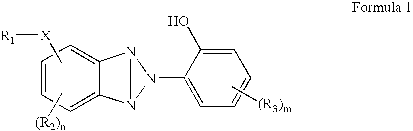
wherein R₁ represents a substituent having a polymerizable group as a substructure; R2 and R3 each represent a substituent; X represents —COO—, —OCO—, —NR₁₁CO—, —CONR₁₁—, —O—, —NR₁₂R₁₃—, —SO₂NR₁₄—, —NR₁₄SO₂—, —S— or —SO₂—; R₁₁, R₁₂, R₁₃, R₁₄ each represent a hydrogen atom, an alkyl group or an aryl group; m represents an integer of 0 to 4; and n represents an integer of 0 to 3.

2. The cellulose acylate optical film of claim 1, wherein a weight average molecular weight of the polymer is 1000 to 20000.

3. The cellulose acylate optical film of claim 1, wherein a content of a monomer unit represented by Formula 1 is 10 to 70% by weight based on a weight of the polymer derived from at least the monomer represented by Formula 1.

4. The cellulose acylate optical film of claim 1, wherein the polymer derived from at least a monomer represented by Formula 1 is a copolymer derived from at least a hydrophilic monomer having an ethylenically unsaturated group and a monomer represented by Formula 1.

5. The cellulose acylate optical film of claim 1, wherein the monomer represented by Formula 1 is a monomer represented by Formula 2: 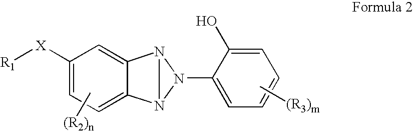
wherein R₁ represents a substituent having a polymerizable group as a substructure; R₂ and R₃ each represent a substituent; X represents —COO—, —OCO—, —NR₁₁CO—, —CONR₁₁—, —O—, —NR₁₂R₁₃—, —SO₂NR₁₄—, —NR₁₄SO₂—, —S— or —SO₂—; R₁₁, R₁₂, R₁₃, R₁₄ each represent a hydrogen atom, an alkyl group or an aryl group; m represents an integer of 0 to 4; and n represents an integer of 0 to 3.

6. The cellulose acylate optical film of claim 1, wherein X in Formula 1 represents —COO—, —OCO—, —NR₁₁CO— or —CONR₁₁—.

7. The cellulose acylate optical film of claim 5, wherein X in Formula 2 represents —COO—, —OCO—, —NR₁₁CO— or —CONR₁₁—.

8. A method to produce a cellulose acylate optical film comprising the steps of:
(i) melting a cellulose acylate;
(ii) casting the cellulose acylate melt on a cooling drum or an endless belt to form a film;
(iii) peeling the film from the cooling drum or the endless belt;
(iv) stretching the film; and
(v) winding the film to form a roll, wherein
(a) the cellulose acylate optical film comprises a polymer derived from at least a monomer represented by Formula 1 and a cellulose acylate having an acyl group of 3 or more carbon atoms; and
(b) a total number of carbon atoms contained in the acyl groups in one glucose unit of the cellulose acylate is larger than 6.0 and not larger than 7.5, wherein the total number of carbon atoms represents a sum of each product of a number of carbon atoms of each acyl group and a substitution degree of the acyl group, wherein the substitution degree represents an average number of 3 hydroxyl groups replaced with an acyl group in one glucose unit of the cellulose acylate: 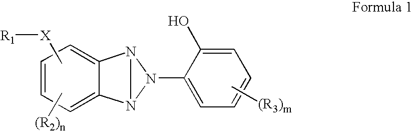
wherein R₁ represents a substituent having a polymerizable group as a substructure; R₂ and R₃ each represent a substituent; X represents —COO—, —OCO—, —NR₁₁CO—, —CONR₁₁—, —O—, —NR₁₂R₁₃—, —SO₂NR₁₄—, —NR₁₄SO₂—, —S— or —SO₂—; R₁₁, R₁₂, R₁₃, R₁₄ each represent a hydrogen atom, an alkyl group or an aryl group; m represents an integer of 0 to 4; and n represents an integer of 0 to 3.

9. A polarizing plate comprising the cellulose acylate optical film of claim 1 provided on at least one surface of a polarizer film.

10. A liquid crystal display comprising the polarizing plate of claim 9 provided at least on one surface of a liquid crystal cell.
